(19) United States
(12) Patent Application Publication
(10) Pub. No.: US 2024/0430074 A1
(43) Pub. Date: Dec. 26, 2024

(54) SECURE COMPUTATION SYSTEM, SECURE COMPUTATION SERVER APPARATUS, SECURE COMPUTATION METHOD, AND SECURE COMPUTATION PROGRAM

(71) Applicant: NEC Corporation, Minato-ku, Tokyo (JP)

(72) Inventor: Hikaru Tsuchida, Tokyo (JP)

(73) Assignee: NEC Corporation, Minato-ku, Tokyo (JP)

(21) Appl. No.: 18/274,136

(22) PCT Filed: Jan. 26, 2021
(86) PCT No.: PCT/JP2021/002598

§ 371 Date: Jul. 25, 2023

(51) Int. Cl. H04L 9/00

(52) U.S. Cl. CPC H04L 9/008; H04L 2209/46

(57) ABSTRACT

An secure computation server apparatus includes: a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher; a shuffle part that shuffles the sequence of the discriminant to conceal information about the digit of the bit for which the discriminant indicates 0; and a comparison and verification part that compares received values with each other, in a communication performed in the shuffling of the discriminant, and adopts the received values that are same at least two received values as an accurate value.

### TECHNICAL FIELD

The present invention relates to a secure computation system, a secure computation server apparatus, a secure computation method, and a secure computation program.

### BACKGROUND ART

In recent years, research and developments on techniques referred to as secure computation are active. Secure computation is one of the techniques for executing predetermined processing while keeping its computation processes and the results thereof secret to third parties. One typical technique used for secure computation is a multiparty computation technique. In this multiparty computation technique, data that needs to be kept secret is distributed to a plurality of servers (secure computation server apparatuses), and each server performs various operations on the data distributed thereto while keeping the data secret. The data distributed to the individual secure computation server apparatuses is called “shares”. Hereinafter, unless otherwise stated, the term “secure computation” signifies the multiparty computation technique.

In the secure computation as described above, computation protocols for specific use are usually implemented in addition to four basic arithmetic operations. As one of the computation protocols for specific use, there are certain kinds of magnitude comparison protocols. As one of the magnitude comparison protocols, there is a magnitude comparison, which is also referred to as Private Compare, between a value on which bit decomposition and secret sharing have been performed and a value which has not been made secret. Although this magnitude comparison also referred to as Private Compare is not often used as itself, the magnitude comparison is used as an internal process in a process such as extraction of the most significant bit or truncation of a numerical value. Thus, it is advantageous to implement the magnitude comparison also referred to as Private Compare as a separate building block in a secure computation system.

### CITATION LIST

### Non-Patent Literature

NPL 1: Byali, M., Chaudhari, H., Patra, A., & Suresh, A. (2020). FLASH: fast and robust framework for privacy-preserving machine learning. Proceedings on Privacy Enhancing Technologies, 2020 (2), 459-480.

### SUMMARY

### Technical Problem

The disclosure of the above citation list is incorporated herein in its entirety by reference thereto. The following analysis has been made by the present inventor.

Different techniques that are generally referred to as secure computation achieve different security levels. For example, a case in which one of the participants in a multiparty secure computation is a dishonest person will be considered. In this case, it is possible to adopt a secure computation technique that can detect the presence of the dishonest person and can abort its processes. Alternatively, it is possible to adopt a secure computation technique that can obtain an accurate computation result without aborting its processes even if there is the dishonest person. The latter technique achieves a higher security than the former technique. The secure computation satisfying the latter security is referred to as Guaranteed Output Delivery (GOD), and an example of the secure computation realizing this GOD is known (for example, see NPL 1).

In addition, regarding the evaluation of the security in the secure computation, not only the advantageous effects of the security that can be achieved, but also pre-conditions have significant implications. A typical pre-condition is use of a random oracle model as a hash function.

A hash function is a function that responds a unique output to an input, and it is difficult to deduce the input from the output. However, although it is difficult to deduce the input from the output, there is no guarantee that the input cannot be deduced from the output. Thus, the security is evaluated on the assumption that the hash function used does not have vulnerability. The security based on this assumption is called “as being secure in the random oracle model”. The security of the secure computation in NPL 1 is “as being secure in the random oracle model”.

In contrast, there is an expression “as being secure in the standard model”, as opposed to “as being secure in the random oracle model”. That is, although the input could be deduced from the output of the hash function, if this itself does not mean vulnerability of the secure computation, the security is referred to “as being secure in the standard model”. Of course, if the same security level is achieved, the security of the standard model is higher than the security of the random oracle model.

Thus, it is desirable to achieve Guaranteed Output Delivery (GOD) in the standard model also in the building block of the magnitude comparison also referred to as Private Compare. This is because, in order to achieve Guaranteed Output Delivery (GOD) in a process such as extraction of the most significant bit or truncation of a numerical value, it is necessary to achieve Guaranteed Output Delivery (GOD) in the standard model also in the building block as its internal process of the process.

The present invention has been made in view of the above problem, and it is an object of the present invention to provide a secure computation system, a secure computation server apparatus, a secure computation method, and a secure computation program that contribute to implementation of a magnitude comparison that achieves Guaranteed Output Delivery (GOD) in the standard model.

### Solution to Problem

According to a first aspect of the present invention, there is provided a secure computation system, which includes five secure computation server apparatuses connected to each other via a network and obtains a share of a result of a magnitude comparison from input of a share relating to a first bit sequence and a value of a cleartext, an individual one of the secure computation server apparatuses including:

a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher: a shuffle part that shuffles the sequence of the discriminant to conceal information about the digit of the bit for which the discriminant indicates 0; and a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

According to a second aspect of the present invention, there is provided a secure computation server apparatus, which is one of five secure computation server apparatuses connected to each other via a network, to obtain a share of a result of a magnitude comparison from input of a share relating to a first bit sequence and a value of a cleartext, the secure computation server apparatus including: a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher: a shuffle part that shuffles the sequence of the discriminant to conceal information about the digit of the bit for which the discriminant indicates 0; and a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

According to a third aspect of the present invention, there is provided a secure computation method, which obtains a share of a result of a magnitude comparison from input of a share relating to a first bit sequence and a value of a cleartext by using five secure computation server apparatuses connected to each other via a network, an individual one of the secure computation server apparatuses performing: determining, per bit, whether the first bit sequence and a second bit sequence into which the value of the cleartext is converted match each other: computing a sequence of a discriminant that indicates 0 when the first bit sequence indicates 1 and the second bit sequence indicates 0 at an n-th bit and when the first bit sequence and the second bit sequence match each other at an (n+1)th bit and higher: shuffling the sequence of the discriminant to conceal information about the digit of the bit for which the discriminant indicates 0; and comparing and verifying, in a communication performed in the shuffling of the discriminant, values with each other, which are received from at least three of the five secure computation server apparatuses and which are supposed to be a same value, and adopting the received values that are same at least two received values as an accurate value.

According to a fourth aspect of the present invention, there is provided a secure computation program, causing five secure computation server apparatuses connected to each other via a network to perform a secure computation, to obtain a share of a result of a magnitude comparison from input of a share relating to a first bit sequence and a value of a cleartext, the secure computation program including: determining, per bit, whether the first bit sequence and a second bit sequence into which the value of the cleartext is converted match each other: computing a sequence of a discriminant that indicates 0 when the first bit sequence indicates 1 and the second bit sequence indicates 0 at an n-th bit and when the first bit sequence and the second bit sequence match each other at an (n+1)th bit and higher: shuffling the sequence of the discriminant to conceal information about the digit of the bit for which the discriminant indicates 0; and comparing and verifying, in a communication performed in the shuffling of the discriminant, values with each other, which are received from at least three of the five secure computation server apparatuses and which are supposed to be a same value, and adopting the received values that are same at least two received values as an accurate value. The program can be recorded in a computer-readable storage medium. The storage medium may be a non-transient storage medium such as a semiconductor memory, a hard disk, a magnetic recording medium, or an optical recording medium. The present invention can be embodied as a computer program product.

### Advantageous Effects of Invention

According to the individual aspects of the present invention, it is possible to provide a secure computation system, a secure computation server apparatus, a secure computation method, and a secure computation program that contribute to implementation of a magnitude comparison that achieves Guaranteed Output Delivery (GOD) in the standard model.

### BRIEF DESCRIPTION OF DRAWINGS

FIG. 1 is a block diagram illustrating a functional configuration example of a secure computation system according to a first example embodiment.

FIG. 2 is a block diagram illustrating a functional configuration example of a secure computation server apparatus according to the first example embodiment.

FIG. 3 is a flowchart illustrating an outline of a procedure of a secure computation method.

FIG. 4 is a block diagram illustrating a functional configuration example of a secure computation system according to a second example embodiment.

FIG. 5 is a block diagram illustrating a functional configuration example of a secure computation server apparatus according to the second example embodiment.

FIG. 6 is a flowchart illustrating a procedure of a protocol for a magnitude comparison (Private Compare).

FIG. 7 is a block diagram illustrating a functional configuration example of a secure computation system according to a third example embodiment.

FIG. 8 is a block diagram illustrating a functional configuration example of a secure computation server apparatus according to the third example embodiment.

FIG. 9 is a flowchart illustrating a procedure of a protocol for extraction of the most significant bit.

FIG. 10 is a diagram illustrating a hardware configuration example of a secure computation server apparatus.

### DESCRIPTION OF EMBODIMENTS

Hereinafter, example embodiments of the present invention will be described with reference to the accompanying drawings. However, the present invention is not limited to the following example embodiments. In addition, in the drawings, the same or equivalent elements are denoted by the same reference characters, as necessary. In addition, the drawings are schematic drawings, and therefore, it should be noted that the sizes, ratios, etc. of the individual elements may differ from their actual sizes, ratios, etc. An element in a drawing may have a portion whose size or ratio differs from that of the portion of the element in a different drawing.

### First Example Embodiment

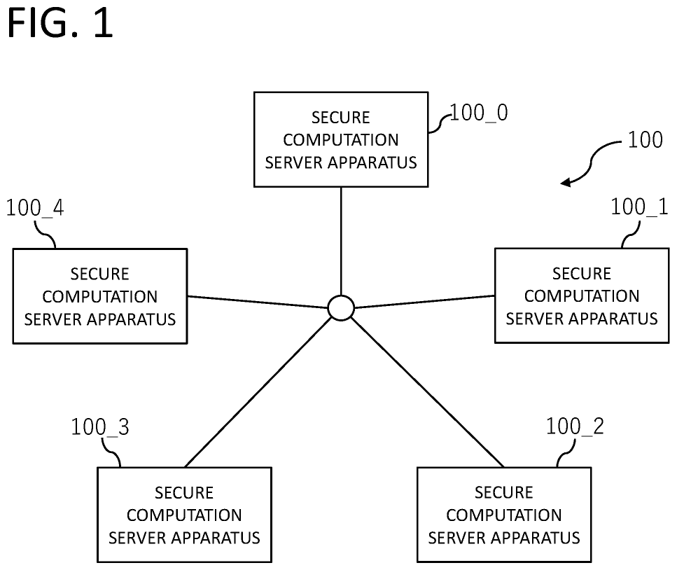

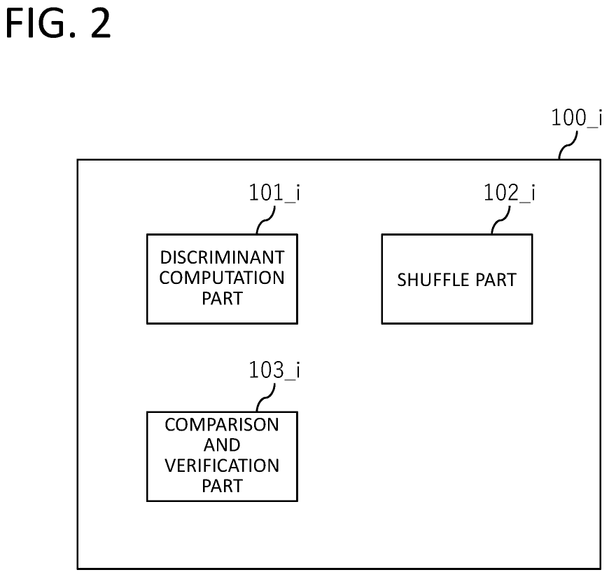

Hereinafter, a secure computation system and secure computation server apparatuses according to a first example embodiment will be described with reference to FIGS. 1 and 2. The first example embodiment is an example embodiment for describing only a basic concept of the present invention.

FIG. 1 is a block diagram illustrating a functional configuration example of a secure computation system according to the first example embodiment. As illustrated in FIG. 1, a secure computation system 100 according to the first example embodiment includes a first secure computation server apparatus 100_0, a second secure computation server apparatus 100_1, a third secure computation server apparatus 100_2, a fourth secure computation server apparatus 100_3, and a fifth secure computation server apparatus 100_4. The first secure computation server apparatus 100_0, the second secure computation server apparatus 100_1, the third secure computation server apparatus 100_2, the fourth secure computation server apparatus 100_3, and the fifth secure computation server apparatus 100_4 are connected to each other via a network such that these apparatuses can communicate with each other.

In the secure computation system 100 including the first to fifth secure computation server apparatuses 100_i (i=0, 1, 2, 3, 4), it is possible to compute target shares from a value inputted to any one of the first to fifth secure computation server apparatuses 100_i (i=0, 1, 2, 3, 4) while keeping the input value and the values acquired in the computation processes secret, and it is possible to dispersedly store the computation results in the first to fifth secure computation server apparatuses 100_i (i=0, 1, 2, 3, 4).

In addition, in the secure computation system 100 including the first to fifth secure computation server apparatuses 100_i (i=0, 1, 2, 3, 4), it is possible to compute target shares from the shares dispersedly stored in the first to fifth secure computation server apparatuses 100_i (i=0, 1, 2, 3, 4) while keeping the values in the computation processes secret, and it is possible to dispersedly store the computation results in the first to fifth secure computation server apparatuses 100_i (i=0, 1, 2, 3, 4).

The shares of the computation results may be reconstructed by causing the first to fifth secure computation server apparatuses 100_0 to 100_4 exchange their shares with each other. Alternatively, the shares may be decoded by transmitting the shares to an external apparatus other than the first to fifth secure computation server apparatuses 100_0 to 100_4.

In addition, in the secure computation system 100 including the first to fifth secure computation server apparatuses 100_i (i=0, 1, 2, 3, 4), even when one of the first to fifth secure computation server apparatuses 100_i (i=0, 1, 2, 3, 4) is operated by a dishonest person, it is possible to continue an accurate secure computation without stopping the processes.

For example, the following construction may be adopted as the construction of the shares that enables continuation of an accurate secure computation without stopping the processes even when one of the first to fifth secure computation server apparatuses 100_i (i=0, 1, 2, 3, 4) is operated by a dishonest person as described above.

Shares of an element x of a residue class ring Zₙ of modulo n, that is, x∈Zₙ, on the residue class ring Zₙ are defined as follows (the shares may be referred to as arithmetic shares, as necessary). Note that n=2ₘ, where m is an integer of 2 or more. That is, a residue class ring Z₂ of modulo 2 is distinguished from the residue class ring Zₙ of modulo n.

An element x of the residue class ring Zₙ of modulo n, that is, x∈Zₙ, is decomposed to satisfy the following relationship:

$$x = x 0 + x 1 + x 2 + x 3 + x 4 mod n$$

[x]i dispersedly held by the individual participants Pi (i=0, 1, 2, 3, 4) is defined as follows.

$$[ x ] i = ( xi + 1 , xi + 2 , xi + 3 ) , note that x 4 + 1 = x 0$$

Shares of an element x of the residue class ring Z₂ of modulo 2, that is, x∈Z₂, on the residue class ring Z₂ (the shares may be referred to as logic shares, as necessary) are defined in the same way as the above shares on the residue class ring Zₙ where n=2. However, a different notation [x]^{B} is used to distinguish the residue class ring Z₂ of modulo 2 from the residue class ring Z₁ of modulo n. That is, the shares are specifically defined as follows.

An element x of the residue class ring Z₂ of modulo 2, that is, x∈Z₂, is decomposed as follows. In Equation 1, “+” inside a circle represents an exclusive-or.

$$x = x\_ 0 ⊕ x\_ 1 ⊕ x\_ 2 ⊕ x\_ 3 ⊕ x\_ 4 mod 2 \qquad [ Equation 1 ]$$

[x]^{B}ᵢ dispersedly held by the individual participants Pᵢ (i=0, 1, 2, 3, 4) is defined as follows.

$$[ x ] Bi = ( xi , xi + 1 , xi + 2 , xi + 3 ) , note that x 4 + 1 = x 0$$

If these shares [x]₀, [x]₁, [x]₂, [x]₃, and [x]₄ held by the individual participants Pᵢ (i=0, 1, 2, 3, 4) are determined as described above, the individual participants Pᵢ (i=0, 1, 2, 3, 4) cannot reconstruct x from their shares [x]₀, [x]₁, [x]₂, [x]₃, and [x]₄ held thereby. However, it is possible to realize secret sharing in which x can be reconstructed if the shares held by at least two of the participants Pᵢ (i=0, 1, 2, 3, 4) are combined. This secret sharing scheme is referred to as a 2-out-of-5 Replicated Secret Sharing Scheme.

In a secure computation based on this secret sharing scheme, not only when x is reconstructed but also when a magnitude comparison is performed, there is a situation in which the individual participants directly or indirectly receive the values of the sub-shares not held thereby from other participants. Thus, if one of the other participants is a dishonest person, a participant could receive a different value instead of a value that the participant is originally supposed to receive. If this happens, the secure computation is performed based on an erroneous value, resulting in an erroneous computation result. In some cases, the computation itself cannot be performed properly.

To solve this problem, as illustrated in FIG. 2, in the secure computation system 100 according to the present example embodiment, an individual one of the first to fifth secure computation server apparatuses 100_i (i=0, 1, 2, 3, 4) includes a discriminant computation part 101,_i a shuffle part 102_i, and a comparison and verification part 103_i. FIG. 2 is a block diagram illustrating a functional configuration example of a secure computation server apparatus according to the first example embodiment. In the secure computation system 100 according to the present example embodiment, since the individual one of the first to fifth secure computation server apparatuses 100_i (i=0, 1, 2, 3, 4) includes the discriminant computation part 101_i, the shuffle part 102_i, and the comparison and verification part 103_i, it is possible to obtain a share of a result of a magnitude comparison from input of a share relating to a first bit sequence and a value of a cleartext.

The discriminant computation part 101_i determines, per bit, whether the first bit sequence and a second bit sequence into which the value of the cleartext is converted match each other and computes a sequence of a discriminant that indicates 0 when the first bit sequence indicates 1 and the second bit sequence indicates 0 at an n-th bit and when the first bit sequence and the second bit sequence match each other at an (n+1)th bit and higher.

The shuffle part 102_i shuffles the sequence of the discriminant to conceal information about the digit of the bit for which the discriminant indicates 0. In addition, the comparison and verification part 103i compares, in a communication performed in the shuffling of the discriminant, values with each other, which are received from at least three of the five secure computation server apparatuses and which are supposed to be the same value, and adopt the received values that are same at least two received values as an accurate value.

Next, the significance of the above configuration will be described based on a magnitude comparison between specific numbers. In practice, a magnitude comparison between a value (share) on which bit decomposition and secret sharing have been performed and a value (cleartext) which has not been made secret is performed. However, for ease of description, cleartexts will be used as the two values in the following example.

As the value (share) on which bit decomposition and secret sharing have been performed, x=40 is set. In addition, as the value (cleartext) which has not been made secret and which will be compared with the value (share), r=32 is set. In this case, if bit decomposition is performed on x=40 and r=32, the values will be represented as follows (binary representation).

$$x = 40 = ( 00101000 )$$

$$x = 32 = ( 00100000 )$$

As is clear from the comparison between the above bit sequences, the first bit sequence (x) indicates 1 and the second bit sequence (r) indicates 0 at the 4^{th} bit, and the first bit sequence (x) and the second bit sequence (r) match each other at the 5^{th} bit and higher. The fact that x is greater than r indicates the presence of n. That is, the first bit sequence indicates 1 and the second bit sequence indicates 0 at an n-th bit, and the first bit sequence and the second bit sequence match each other at an (n+1)th bit and higher. When x=40 and r=32, n=4.

By using this nature, the discriminant computation part 101_i determines, per bit, whether the first bit sequence and the second bit sequence into which the value of the cleartext is converted match each other and computes a sequence of a discriminant that indicates 0 when the first bit sequence indicates 1 and the second bit sequence indicates 0 at an n-th bit and when the first bit sequence and the second bit sequence match each other at an (n+1)th bit and higher.

Specifically, the discriminant can be configured as follows. Note that the following discriminant is used for a cleartext. An actual discriminant will be described below. In addition, “|₁” in Equations 2 represents an lth bit.

$$c {\vert}_{l} = r {\vert}_{l} - x {\vert}_{l} + 1 + {\sum }_{m = l + 1}^{k - 1} w {\vert}_{m} \qquad [ Equations 2 ]$$

$$w {\vert}_{m} = x {\vert}_{l} + r {\vert}_{l} - 2 r {\vert}_{l} \times x {\vert}_{l}$$

When x=40 and r=32, the discriminant is computed as follows. Note that “*” represents a non-zero value.

$$x = 40 = ( 00101000 )$$

$$r = 32 - ( 00100000 )$$

$$c = \text{(*} ** * 0 \text{***)}$$

As described above, this discriminant c is configured such that x>r if the sequence includes 0.

Although the discriminant c can determine that x>r if the sequence includes 0, the discriminant c includes excess information. That is, the location of 0 in the sequence indicates information about the difference between x and r. Thus, the shuffle part 102_i shuffles the sequence of the discriminant to conceal information about the digit of the bit for which the discriminant indicates 0.

In addition, the comparison and verification part 103_i compares, in a communication performed in the shuffling of the discriminant, values with each other, which are received from at least three of the five secure computation server apparatuses and which are supposed to be the same value, and adopts the received values that are same at least two received values as an accurate value. Consequently, Guaranteed Output Delivery (GOD) is achieved in the standard model.

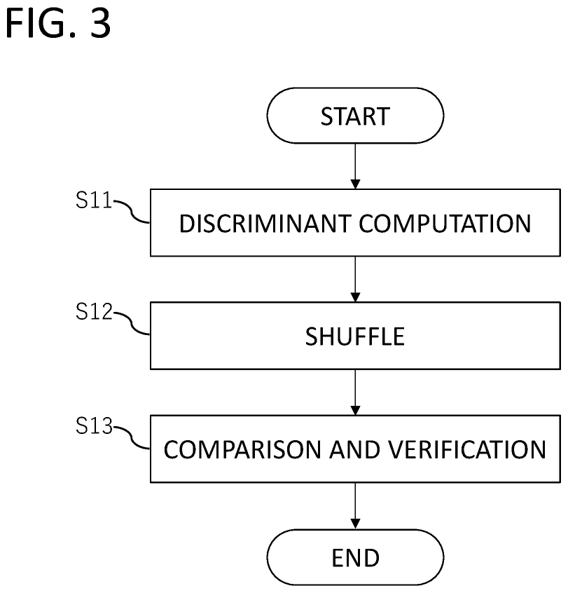

Next, a secure computation method according to the present example embodiment will be described. FIG. 3 is a flowchart illustrating an outline of a procedure of the secure computation method.

As illustrated in FIG. 3, the secure computation method according to the present example embodiment includes a discriminant computation step (S11), a shuffle step (S12), and a comparison and verification step (S13). In the discriminant computation step (S11), the discriminant computation part 101_i determines, per bit, whether the first bit sequence and the second bit sequence into which the value of the cleartext is converted match each other and computes a sequence of a discriminant that indicates 0 when the first bit sequence indicates 1 and the second bit sequence indicates 0 at an n-th bit and when the first bit sequence and the second bit sequence match each other at an (n+1)th bit and higher. In the shuffle step (S12), the shuffle part 102_i shuffles the sequence of the discriminant to conceal information about the digit of the bit for which the discriminant indicates 0. Next, in the comparison and verification step (S13), the comparison and verification part 103i compares, in a communication performed in the shuffling of the discriminant, values with each other, which are received from at least three of the five secure computation server apparatuses and which are supposed to be the same value, and adopts the received values that are same at least two received values as an accurate value.

As described above, in the secure computation system 100 and the secure computation method according to the present example embodiment, a participant receives values, which are received from at least three of the other participants and which are supposed to be the same value, and adopts the received values that are same at least two received values as an accurate value. In this way, even if one of the other participants is a dishonest person, the participant can determine an accurate value. That is, even if there is a dishonest person, it is possible to realize Guaranteed Output Delivery (GOD) that can acquire an accurate computation without stopping the processes. In addition, because no hash function is used in the above processes, Guaranteed Output Delivery (GOD) is realized in the standard model.

The first example embodiment described above is an example embodiment for describing only a basic concept of the present invention. A second example embodiment described below is a practical example embodiment to which the above-described concept is applied.

### Second Example Embodiment

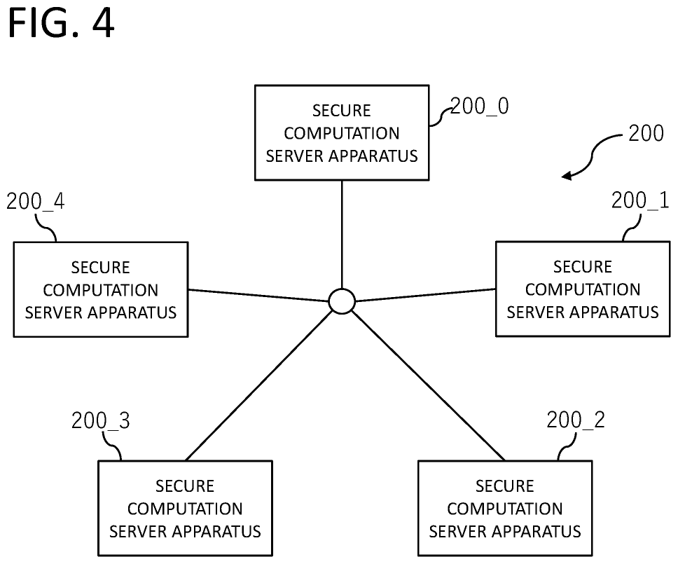

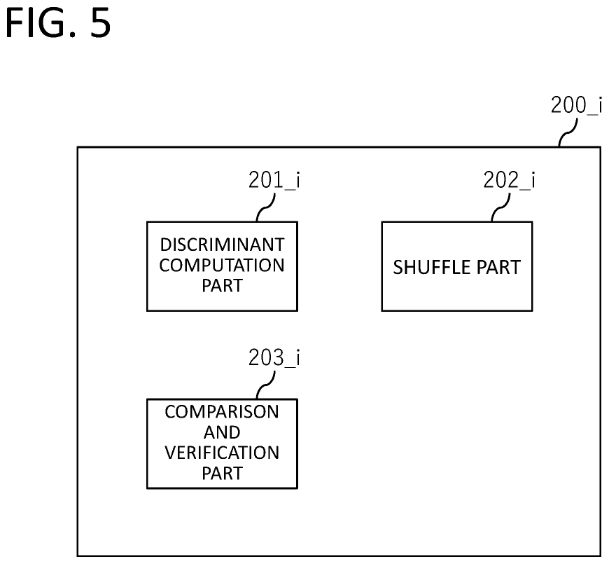

Hereinafter, a secure computation system and secure computation server apparatuses according to a second example embodiment will be described with reference to FIGS. 4 and 5.

FIG. 4 is a block diagram illustrating a functional configuration example of a secure computation system according to the second example embodiment. As illustrated in FIG. 4, a secure computation system 200 according to the second example embodiment includes a first secure computation server apparatus 200_0, a second secure computation server apparatus 200_1, a third secure computation server apparatus 200_2, a fourth secure computation server apparatus 200_3, and a fifth secure computation server apparatus 200_4. The first secure computation server apparatus 200_0, the second secure computation server apparatus 200_1, the third secure computation server apparatus 200_2, the fourth secure computation server apparatus 200_3, and the fifth secure computation server apparatus 200_4 are connected to each other via a network such that these apparatuses can communicate with each other.

In the secure computation system 200 including the first to fifth secure computation server apparatuses 200_i (i=0, 1, 2, 3, 4), it is possible to compute target shares from a value inputted to any one of the first to fifth secure computation server apparatuses 200_i (i=0, 1, 2, 3, 4) while keeping the input value and the values acquired in the computation processes secret, and it is possible to dispersedly store the computation results in the first to fifth secure computation server apparatuses 200_i (i=0, 1, 2, 3, 4).

In addition, in the secure computation system 200 including the first to fifth secure computation server apparatuses 200_i (i=0, 1, 2, 3, 4), even when one of the first to fifth secure computation server apparatuses 200_i (i=0, 1, 2, 3, 4) is operated by a dishonest person, it is possible to continue an accurate secure computation without stopping the processes.

FIG. 5 is a block diagram illustrating a functional configuration example of a secure computation server apparatus according to the second example embodiment. As illustrated in FIG. 5, in the secure computation system 200 according to the present example embodiment, an individual one of the first to fifth secure computation server apparatuses 200_i (i=0, 1, 2, 3, 4) includes a discriminant computation part 201_i a shuffle part 202_i, and a comparison and verification part 203_i. In the secure computation system 200 according to the present example embodiment, since the individual one of the first to fifth secure computation server apparatuses 200_i (i=0, 1, 2, 3, 4) includes the discriminant computation part 201,_i the shuffle part 202_i, and the comparison and verification part 203,_i it is possible to obtain a share of a result of a magnitude comparison from input of a share relating to a first bit sequence and a value of a cleartext.

Hereinafter, building blocks used for execution of the magnitude comparison according to the present example embodiment will be described. Note that not all the building blocks used for execution of the magnitude comparison will be described. Of all the four basic arithmetic operations used for the secure computation, multiplication, which is not obvious, will be mainly described. In addition, shuffle, bit conversion, reshare, and reconstruction, which are used in the magnitude comparison described below, will also be described.

### [Generation of Pseudo Random Numbers and Sharing of Seeds]

Pseudo-random functions Fₙ and F₂, seeds, and an identifier have a relationship as follows. The pseudo-random functions Fₙ and F₂ are binary operations defined with a security parameter K.

$${F}_{n} : {\{ 0 , 1 \}}^{κ} \times {\{ 0 , 1 \}}^{κ} \to {\{ 0 , 1 \}}^{n}$$

$${F}_{2} : {\{ 0 , 1 \}}^{κ} \times {\{ 0 , 1 \}}^{κ} \to {\{ 0 , 1 \}}^{2}$$

Seeds seedᵢ∈{0,1}^{k} (i=0, 1, 2, 3, 4) are values appropriately shared by the individual secure computation server apparatuses 200_i, and an identifier vid∈{0,11} is a public value such as a counter. The pseudo-random functions Fₙ and F₂ determinably generate pseudo random numbers by using the seeds and the identifier as their inputs.

Regarding the five seeds seedᵢ∈{0,1}^{k} (i=0, 1, 2, 3, 4), an individual one of the secure computation server apparatuses 200_i holds (seedᵢ, seedᵢ₊₁, seedᵢ₊₂, seedᵢ₊₃). Note that seed₄₊₁=seed₀. That is, an individual one of the secure computation server apparatuses 200_i holds the seeds seedᵢ other than the seed seedᵢ₊₄. For example, the sharing of these seeds can be appropriately set by an administrator or the like as a presetting of the secure computation server apparatuses 200_i.

### [Creation of Mask]

Next, a pseudo random number (Correlated Randomness) that is seen as a random number by the participant Pᵢ₊₄ and cannot be removed and that can be determinably computed by the other participants Pᵢ, Pᵢ₊₁, Pᵢ₊₂, and Pᵢ₊₃ is created, and this pseudo random number will be used as a mask in the multiplication in the secure computation, which will be described below.

First, since the participant Pᵢ₊₄ does not hold the seed seedᵢ₊₃, if the seed seedᵢ₊₃ is used as an input of the pseudo-random function Fₙ, the following pseudo random number satisfies the above condition. That is, although the following αₖ is seen as a random number by the participant Pᵢ₊₄ and cannot be removed, the following αₖ can be determinably computed by the other participants Pᵢ, Pᵢ₊₁, Pᵢ₊₂, and Pᵢ₊₃.

$${α}_{k} = {F}_{n} ( {vid}_{k} , {seed}_{i + 3} ) - {F}_{n} ( {vid}_{k + 1} , {seed}_{i + 3} ) mod n$$

In addition, by changing the index k in the identifier vidₖ from k=0 to k=4, five pseudo random numbers αₖ can be created. A set of these pseudo random numbers αₖ is defined as follows. Whether the following pseudo random numbers α₀, α₁, α₂, α₃, and α₄ determined as follows satisfy α₀+α1+α2+α3+α4=0 can be easily determined.

$$( {α}_{0} , {α}_{1} , {α}_{2} , {α}_{3} , {α}_{4} ) = CR ( i + 4 , {\{ {vid}_{k} \}}_{k = 0}^{4} , {seed}_{i + 3} )$$

Although the pseudo random numbers α₀, α₁, α₂, α₃, and α₄ created as described above are seen as random numbers by the participant Pᵢ₊₄ and cannot be removed, these pseudo random numbers can be determinably computed by the other participants Pᵢ, Pᵢ₊₁, Pᵢ₊₂, and Pᵢ₊₃. However, although the pseudo random numbers α₀, α₁, α₂, α₃, and α₄ cannot be removed by the participant Pᵢ₊₄, if all the pseudo random numbers α₀, α₁, α₂, α₃, and α₄ are collected, because the sum is 0, the pseudo random numbers α₀, α₁, α₂, α₃, and α₄ can be removed by the participant Pᵢ₊₄.

In addition, the creation of the above pseudo random numbers can be performed in the same way by all the other participants Pᵢ. Specifically, the pseudo random numbers can be defined as follows.

$$( {α}_{i , 0} , {α}_{i , 1} , {α}_{i , 2} , {α}_{i , 3} , {α}_{i , 4} ) = CR ( i , {\{ {vid}_{k} \}}_{k = 0}^{4} , {seed}_{i + 4} )$$

$$for$$

$$i = 0 , 1 , 2 , 3 , 4$$

$${a}_{i , k} = {F}_{n} ( {vid}_{k} , {seed}_{i + 4} ) - {F}_{n} ( {vid}_{k + 1} , {seed}_{i + 4} ) mod n$$

$$for$$

$$i = 0 , 1 , 2 , 3 , 4$$

The sets of pseudo random numbers created as described above are defined as follows.

TABLE 1

| | | | | |
|---|---|---|---|---|
| α_{0, 0} | α_{1, 0} | α_{2, 0} | α_{3, 0} | α_{4, 0} |
| α_{0, 1} | α_{1, 1} | α_{2, 1} | α_{3, 1} | α_{4, 1} |
| α_{0, 2} | α_{1, 2} | α_{2, 2} | α_{3, 2} | α_{4, 2} |
| α_{0, 3} | α_{1, 3} | α_{2, 3} | α_{3, 3} | α_{4, 3} |
| α_{0, 4} | α_{1, 4} | α_{2, 4} | α_{3, 4} | α_{4, 4} |

In the above table of the pseudo random numbers, the sum of first indexes (in the vertical direction) is zero, and the sum of second indexes (in the horizontal direction) is not zero.

[Secure Computation (Multiplication)]

Next, multiplication, which is an important factor in the secure computation, will be described. That is, a specific example of a secure computation for computing [z]=[x y]=[x] [y] from two shares [x] and [y] will be described. Note that x, y, and z have been decomposed as follows.

$$z = {\sum }_{i = 0}^{4} {z}_{i} mod n \qquad [ Equations 3 ]$$

$$x = {\sum }_{i = 0}^{4} {x}_{i} mod n$$

$$y = {\sum }_{i = 0}^{4} {y}_{i} mod n$$

$${z}_{i} = {x}_{i} \cdot {\sum }_{j = 0}^{4} {y}_{j} mod n$$

The participant Pᵢ (i=0, 1, 2, 3, 4) computes tmp_{zk} as follows. xₖ·yᵢ₊₄ is needed for the participant Pᵢ to compute zₖ (the participant Pᵢ cannot compute zₖ from the share held thereby), and this tmp_{zk} is a value that the participant Pᵢ computes instead. The following α_{j,k} represents a pseudo random number described in the above section

### [Creation of Mask].

$${tmp}_{{z}_{k}} = {x}_{k} \cdot ( {y}_{i} + {y}_{i + 1} + {y}_{i + 2} + {y}_{i + 3} ) + {\sum }_{j \neq i} {a}_{j , k} mod n \qquad [ Equation 4 ]$$

$$( k = i , i + 1 , i + 2 , i + 3 )$$

Next, sender groups Sᵢ, Sᵢ₊₁, Sᵢ₊₂, and Sᵢ₊₃ are defined as Sᵢ {Pᵢ₊₂, Pᵢ₊₃, Pᵢ₊₄}, Sᵢ₊₁={Pᵢ₊₃, Pᵢ₊₄, Pᵢ₊₁₁}, Sᵢ₊₂={Pᵢ₊₄, Pᵢ₊₁, Pᵢ₊₂}, and Sᵢ₊₃={Pᵢ₊₁, Pᵢ₊₂, Pᵢ₊₃}. In this way, the participants belonging to Sₖ can compute xₖyᵢ₊₄ from the shares held thereby. Thus, for example, the participants Pᵢ₊₂, Pᵢ₊₃, and Pᵢ₊₄ belonging to the sender group Sᵢ={Pᵢ₊₂, Pᵢ₊₃, Pᵢ₊₄} compute m_{k,i+2}, m_{k,i+3}, and m_{k,i+4} in which xₖ·yᵢ₊₄ is masked by the above pseudo random number α_{i,k}.

$${P}_{i + 2} : {m}_{k , i + 2} = {α}_{i , k} + {x}_{k} \cdot {y}_{i + 4} mod n$$

$${P}_{i + 3} : {m}_{k , i + 3} = {α}_{i , k} + {x}_{k} \cdot {y}_{i + 4} mod n$$

$${P}_{i + 4} : {m}_{k , i + 4} = {α}_{i , k} + {x}_{k} \cdot {y}_{i + 4} mod n$$

In addition, among the participants Pᵢ₊₂, Pᵢ₊₃, and Pᵢ₊₄ belonging to the sender group Sᵢ={Pᵢ₊₂, Pᵢ₊₃, Pᵢ₊₄}, for example, the participants Pᵢ₊₂ and Pᵢ₊₃ send m_{k,i+2} and m_{k,i+3} to the participant Pᵢ without change, and the participant Pᵢ₊₄ sends a hash value h_{k,i+4} of m_{k,i+4} to the participant Pᵢ. In this case, since m_{k,i+2}, m_{k,i+3}, and m_{k,i+4} are masked by the pseudo random number α_{i, k}, xₖyᵢ₊₄ will not be leaked. That is, although a hash function is used in this case, use of the hash function is not for ensuring security but for reducing the communication cost.

Next, upon receiving m_{k,i+2} and m_{k,i+3} and the hash value h_{k,i+4} of m_{k,i+4}, the participant Pᵢ performs comparison and verification on m_{k,i+2} and m_{k,i+3} and the hash value h_{k,i+4} of m_{k,i+4}. First, the participant Pᵢ computes hash values h_{k,i+2} and h_{k,i+3} of m_{k,i+2} and m_{k,i+3}. Next, if h_{k,i+2}=h_{k,i+3} or if h_{k,i+2}=h_{k,i+4}, the participant Pᵢ determines that mk=k, i+2. If h_{k,i+3}=h_{k,i+4}, the participant Pᵢ determines that mk=Ink, i+2.

When xₖyᵢ₊₄ is sent to the participant Pᵢ as described above, the participant Pᵢ receives the values mₖ (hash values thereof), which are supposed to be the same value, from at least three of the other participants Pⱼ and adopts the received values that are same at least two received values as an accurate value. In this way, even when one of the other participants Pⱼ is a dishonest person, it is possible to determine an accurate value.

Next, the participant Pᵢ computes zₖ=tmp_{zk}+mₖ mod n (k=i i+1, i+2, i+3) by using mₖ, which has been determined to be an accurate value.

$$[ Equation 5 ]$$

$${z}_{k} = {tmp}_{{z}_{k}} + {m}_{k} = ( {x}_{k} \cdot ( {y}_{i} + {y}_{i + 1} + {y}_{i + 2} + {y}_{i + 3} ) + {\sum }_{j \neq i} {α}_{j , k} ) + ( {α}_{i , k} + {x}_{k} \cdot {y}_{i + 4} ) = {x}_{k} \cdot {\sum }_{j = 0}^{4} {y}_{j} + {\sum }_{j = 0}^{4} {α}_{j , k}$$

Although zₖ computed as described above includes an extra additional term, zₖ functions as a share [z]ᵢ=(zᵢ, zᵢ₊₁, zⱼ₊₂, zᵢ₊₃) of the computation result of [z]=[xy]=[x][y]. This becomes clear when z=z₀+z₁+z₂+z₃+z₄ is actually computed as follows.

$$[ Equation 6 ]$$

$$z = {z}_{0} + {z}_{1} + {z}_{2} + {z}_{3} + {z}_{4} = ( {x}_{0} \cdot {\sum }_{j = 0}^{4} {y}_{j} + {\sum }_{j = 0}^{4} {α}_{j , 0} ) + ( {x}_{1} \cdot {\sum }_{j = 0}^{4} {y}_{j} + {\sum }_{j = 0}^{4} {α}_{j , 1} ) + ( {x}_{2} \cdot {\sum }_{j = 0}^{4} {y}_{j} + {\sum }_{j = 0}^{4} {α}_{j , 2} ) + ( {x}_{3} \cdot {\sum }_{j = 0}^{4} {y}_{j} + {\sum }_{j = 0}^{4} {α}_{j , 3} ) + ( {x}_{4} \cdot {\sum }_{j = 0}^{4} {y}_{j} + {\sum }_{j = 0}^{4} {α}_{j , 4} ) = ( {x}_{0} + {x}_{1} + {x}_{2} + {x}_{3} + {x}_{4} ) \cdot {\sum }_{j = 0}^{4} {y}_{j} + {\sum }_{k = 0}^{4} {α}_{0 , k} + {\sum }_{k = 0}^{4} {α}_{1 , k} + {\sum }_{k = 0}^{4} {α}_{2 , k} + {\sum }_{k = 0}^{4} {α}_{3 , k} + {\sum }_{k = 0}^{4} {α}_{4 , k} = x \cdot y mod n$$

The reason why the pseudo random number α_{i,k} can be removed is that the following relational expression is established from the construction of the pseudo random number.

$${\sum }_{k = 0}^{4} {α}_{0 , k} + {\sum }_{k = 0}^{4} {α}_{1 , k} + {\sum }_{k = 0}^{4} {α}_{2 , k} + {\sum }_{k = 0}^{4} {α}_{3 , k} + {\sum }_{k = 0}^{4} {α}_{4 , k} = 0 \qquad [ Equation 7 ]$$

That is, as described in the above section [Creation of Mask], the pseudo random numbers having the present construction have the nature that the sum of first indexes (in the vertical direction) is zero and that the sum of second indexes (in the horizontal direction) is not zero. The additional term that appears in the computation result of zₖ=tmp_{zk}+mₖ mod n (k=i, i+1, i+2, i+3) is the sum of the second indexes (in the horizontal direction) and is not zero. However, when the computation result of [z]=[x y]=[x] [y] is reconstructed, it becomes consequently possible to remove the impact of the additional term (mask) by using the nature that the sum of first indexes (in the vertical direction) is zero. That is, although zₖ computed as described above includes the extra additional term, zₖ functions as a share [z]ᵢ=(zᵢ, zᵢ₊₁, zᵢ₊₂, zᵢ₊₃) of the computation result of [z]=[x·y]=[x]·[y].

Thus, regarding the share [z]ᵢ=(zᵢ, zᵢ₊₁, zᵢ₊₂, zᵢ₊₃) of the computation result of [z]=[x·y]=[x]·[y] as described above, a participant Pᵢ receives the values mₖ (hash values thereof), which are supposed to be the same value, from at least three of the other participants Pⱼ and adopts the received values that are same at least two received values as an accurate value. In this way, even when one of the other participants Pⱼ is a dishonest person, it is possible to determine an accurate value. That is, even if there is a dishonest participant, it is possible to realize Guaranteed Output Delivery (GOD) that can acquire an accurate computation without stopping the processes. In addition, although a hash function is used in the above processes, this is to reduce the communication amount. Even if the input is deduced from the output, the security is not affected. Thus, Guaranteed Output Delivery (GOD) in a standard model is realized.

### [Reshare]

The reshare used in the present example embodiment is defined as follows. That is, the reshare is determinably defined from seeds and an identifier when participants Pᵢ, Pᵢ₊₁, and Pᵢ₊₂ hold a value c.

$$[ c ] ← Reshare ( {P}_{i} , {P}_{i + 1} , {P}_{i + 2} , c , {\{ {vid}_{j} \}}_{j = 1}^{4} , {seed}_{i + 2} , {seed}_{i + 3} ) \qquad [ Equation 8 ]$$

$${c}_{i} = \{ \begin{matrix}c - {r}_{1} - {r}_{2} - {r}_{3} - {r}_{4} - {r}_{1}^{′} - {r}_{2}^{′} - {r}_{3}^{′} - {r}_{4}^{′} ( i = 0 ) \\ {r}_{i} = {r}_{i}^{′} ( else )\end{matrix}$$

$$where$$

$$c = {c}_{0} + {c}_{1} + {c}_{2} + {c}_{3} + {c}_{4} mod n$$

Note that rⱼ=Fₙ(vidₖ, seedᵢ₊₂) and r′j=Fₙ(vidₖ₊₁, seedᵢ₊₃), and that the seeds seedᵢ∈{0,1}^{k} (i=0, 1, 2, 3, 4) are those having the nature described in the above section [Generation of Pseudo Random Number and Sharing of Seeds]. Thus, a participant Pᵢ₊₃ does not know seedᵢ₊₂, and a participant Pᵢ₊₄ does not know seedᵢ₊₃. That is, the participant Pᵢ₊₃ cannot compute cᵢ₊₃ by himself or herself and the participant Pᵢ₊₄ cannot compute cᵢ₊₄ by himself or herself. Therefore, the participant Pᵢ₊₃ needs to receive cᵢ₊₃ from the participants Pᵢ, Pᵢ₊₁, and Pᵢ₊₂, and the participant Pᵢ₊₄ needs to receive cᵢ₊₄ from the participants Pᵢ, Pᵢ₊₁, and Pᵢ₊₂.

In this step, since a secure computation with communications is performed, the participant Pᵢ₊₃ compares the received values cᵢ₊₃, which are received from the participants Pᵢ, Pᵢ₊₁, and Pᵢ₊₂ and which are supposed to be the same value, and adopts the received values that are same at least two received values as an accurate value. Similarly, the participant Pᵢ₊₄ compares the received values cᵢ₊₄, which are received from the participants Pᵢ, Pᵢ₊₁, and Pᵢ₊₂ and which are supposed to be the same value, and adopts the received values that are same at least two received values as an accurate value. Specifically, this step can be performed as follows.

The participants Pᵢ and Pᵢ₊₁ send cⱼ₊₁, cⱼ₊₂, and cⱼ₊₃ (j=i+3) to the participant Pᵢ₊₃. In contrast, the participant Pᵢ₊₂ sends hash values of cⱼ₊₁, cⱼ₊₂, and cⱼ₊₃ (j=i+3) to the individual participant. In addition, the participants Pᵢ and Pᵢ₊₁ send c_{j′+1}, c_{j′+2}, and c_{j′+3} (j′=i+3) to the participant Pᵢ₊₄. In contrast, the participant Pᵢ₊₂ sends c_{j′+1}, c_{j′+2}, and c_{j′+3} (j′=i+3) to the individual participant. Next, each of the participants Pᵢ₊₃ and Pᵢ₊₄ adopts the received values received from the participants Pᵢ, Pᵢ₊₁, and Pᵢ₊₂ that are same at least two received values as an accurate value.

Next, how the above-described reshare is used in the bit conversion will be described.

### [Bit Conversion]

The bit conversion is a bit conversion: [x]←BC([x]^{B}) for acquiring arithmetic shares [x] on a residue class ring Zₙ of modulo n from logic shares [x]^{B} on a residue class ring Z₂ of modulo 2. First, the participants P₃, P₄, and P₀ and the participants P₀, P₁, and P₂ compute temporary variables y₀ and y₁ from sub-shares xᵢ in the logic share [x]^{B} as follows.

$${y}_{0} = {x}_{0} ⊕ {x}_{1} \qquad [ Equations 9 ]$$

$${y}_{1} = {x}_{2} ⊕ {x}_{3}$$

Next, the participants P₃, P₄, and P₀ and the participants P₀, P₁, and P₂ reshare the temporary variables y₀ and y₁.

$$[ {y}_{0} ] ← Reshare ( {P}_{3} , {P}_{4} , {P}_{0} , {y}_{0} , {\{ {vid}_{0 , k} \}}_{k = 1}^{4} , {seed}_{0} , {seed}_{1} ) \qquad [ Equations 10 ]$$

$$[ {y}_{1} ] ← Reshare ( {P}_{0} , {P}_{1} , {P}_{2} , {y}_{1} , {\{ {vid}_{1 , k} \}}_{k = 1}^{4} , {seed}_{2} , {seed}_{3} )$$

As described above, since the above reshare is a secure computation with communications, each of the participants Pᵢ₊₃ and Pᵢ₊₄ adopts the received values received from the participants Pᵢ, Pᵢ₊₁, and Pᵢ₊₂ that are same at least two received values as an accurate value.

In contrast, the individual participant Pᵢ (i=0, 1, 2, 3, 4) sets [x₄]ᵢ as follows. This process is not a secure computation with communications, and therefore, no verification is needed.

$${P}_{0} {: [ {x}_{4} ]}_{0} = ( 0 , 0 , 0 , 0 )$$

$${P}_{1} {: [ {x}_{4} ]}_{1} = ( 0 , 0 , 0 , {x}_{4} )$$

$${P}_{2} {: [ {x}_{4} ]}_{2} = ( 0 , 0 , {x}_{4} , 0 )$$

$${P}_{3} {: [ {x}_{4} ]}_{3} = ( 0 , {x}_{4} , 0 , 0 )$$

$${P}_{4} {: [ {x}_{4} ]}_{4} = ( {x}_{4} , 0 , 0 , 0 )$$

Next, finally, by using the arithmetic shares of the temporary variables y₀ and y₁ and the arithmetic shares [x₄]ᵢ (i=0, 1, 2, 3, 4), the individual participant Pi (i=0, 1, 2, 3, 4) performs a secure computation as follows to obtain an arithmetic share from the logic share through a bit conversion.

$$[ {y}_{1} ⊕ {x}_{4} ] = {( [ {y}_{1} ] - [ {x}_{4} ] )}^{2} \qquad [ Equations 11 ]$$

$$[ x ] = [ {y}_{1} ⊕ {x}_{4} ⊕ {y}_{0} ] = {( [ {y}_{1} ⊕ {x}_{4} ] - [ {y}_{0} ] )}^{2}$$

The above secure computation includes multiplications. By using the above [Secure Computation (Multiplication)], a secure computation server apparatus compares received values with each other, which are received from at least three of the secure computation server apparatuses and which are supposed to be the same value, and adopts the received values that are same at least two received values as an accurate value. In this way, the secure computation server apparatus verifies the received values acquired in the secure computation with communications.

As described above, in the secure computation system 200 and the secure computation method according to the second example embodiment, a participant receives received values, which are received from at least three of the other participants and which are supposed to be the same value, and adopts the received values that are same at least two received values as an accurate value. In this way, even if one of the other participants is a dishonest person, the participant can determine an accurate value. That is, even if there is a dishonest person, it is possible to realize Guaranteed Output Delivery (GOD) that can acquire an accurate computation without stopping the processes.

In addition, although a hash function is used in the above processes, this is to reduce the communication amount. Even if the input is deduced from the output, the security is not affected. Thus, Guaranteed Output Delivery (GOD) in the standard model is realized.

In addition, in the secure computation system 200 and the secure computation method according to the present example embodiment, because reshare (local reshare) is first performed without communications, and a secure computation with communications is next performed, reduction in communication cost is achieved.

### [Shuffle]

First, the following description will be made on an example in which, among the participants Pᵢ (i=0, 1, 2, 3, 4), each of the participants Pᵢ (i=1, 2, 3, 4) computes a permutation of the participant P₀ for the participant P₀ by using a permutation shared thereby and sends the computed permutation to the participant P₀.

A permutation Go E S_{M} shared by the participants Pᵢ (i=1, 2, 3, 4) is constructed as follows. As described above, the participants Pᵢ (i=0, 1, 2, 3, 4) hold the seeds (seedᵢ, seedᵢ₊₁, seedᵢ₊₂, seedᵢ₊₃). In other words, each participant Pᵢ (i=0, 1, 2, 3, 4) does not hold the seed seedᵢ₊₄. That is, while the participant P₀ does not hold the seed seed₄, the other participants Pᵢ (i=1, 2, 3, 4) hold the seed seed₄. Thus, the permutation σ₀∈S_{M} shared by the participants Pᵢ (i=1, 2, 3, 4) is constituted by using a pseudo random number generated by using the seed seed₄. In this way, although the permutation σ₀∈S_{M} is traceable by the participants Pᵢ (i=1, 2, 3, 4), the permutation σ₀∈S_{M} is not traceable by the participant P₀.

Next, by using the permutation σ₀∈S_{M} constructed as described above and the pseudo random number rₖ, each of the participants Pᵢ (i=1, 2, 3, 4) computes the permutation of the participant P₀ for the participant P₀ and sends the computed permutation to the participant P₀ as follows. It should be noted here that, from the method of constructing the shares in secret sharing, there are shares shared by the participants Pᵢ (i=1, 2, 3, 4) and the participant P₀, and that the participants Pᵢ (i=1, 2, 3, 4) can compute the permutation of the participant P₀ for the participant P₀.

$$\{ {P}_{2} , {P}_{3} , {P}_{4} \} : \vec{{r}_{0}} + {σ}_{0} ( \vec{{x}_{0}} ) \qquad [ Equations 12 ]$$

$$\{ {P}_{1} , {P}_{3} , {P}_{4} \} : \vec{{r}_{1}} + {σ}_{0} ( \vec{{x}_{1}} )$$

$$\{ {P}_{1} , {P}_{2} , {P}_{4} \} : \vec{{r}_{2}} + {σ}_{0} ( \vec{{x}_{2}} )$$

$$\{ {P}_{1} , {P}_{2} , {P}_{3} \} : \vec{{r}_{3}} + {σ}_{0} ( \vec{{x}_{3}} )$$

$$\vec{{x}_{l}} = ( {x}_{0 , i} , … , {x}_{M - 1 , i} ) ( i = 0 , 1 , 2 , 3 )$$

$${x}_{j} = {x}_{j , 0} + {x}_{j , 1} + {x}_{j , 2} + {x}_{j , 3} + {x}_{j , 4} mod L$$

$$\vec{{r}_{l}} = ( {r}_{i , 0} , … , {r}_{i , j} , … , {r}_{i , m - 1} )$$

$${r}_{0 , j} + {r}_{1 , j} + {r}_{2 , j} + {r}_{3 , j} + {r}_{4 , j} = 0 mod L ( j = 0 , … , m - 1 )$$

In the above transmission, note that the participants P₂, P₃, P₄ send the same value to the participant P₀, the participants P₁, P₃, P₄ send the same value to the participant P₀, the participants P₁, P₂, P₄ send the same value to the participant P₀, the participants P₁, P₂, P₃ send the same value to the participant P₀. From this nature, the participant P₀ can compare the values of the permutations of the shares, which are received from three participants and which are supposed to be the same value, and can adopt the received values that are same at least two received values as an accurate permutation. That is, even if one of the other participants is a dishonest person, the participants can determine an accurate value. That is, even if there is a dishonest person, it is possible to realize Guaranteed Output Delivery (GOD) that can acquire an accurate computation without stopping the processes.

In addition, in the above transmission, by using a hash function shared by the participants Pᵢ (i=1, 2, 3, 4) and transmitting the hash value as follows, the communication amount can be reduced. First, one of the three participants converts a value by using the hash function and sends the obtained hash value to the participant P₀. The other two participants send the value, not a hash value, to the participant P₀ without change. Upon receiving the value, the participant P₀ converts the value into a hash value by using the hash function. Next, the participant P₀ compares the hash values with each other. If at least two of the hash values match each other, the participant P₀ adopts this value as an accurate value.

By performing the process as described above, a share corresponding to the permutation σ₀∈S_{M} that can be computed by the participants Pᵢ (i=1, 2, 3, 4) and that cannot be computed by the participant P₀ can be constituted as follows. This is referred to as a mini-shuffle.

$$[ Equations 13 ]$$

$${P}_{i} {: [ {σ}_{0} ( \vec{x} ) ]}_{L , i} = ( \vec{{r}_{l}} + {σ}_{0} ( \vec{{x}_{l}} ) , \vec{{r}_{l + 1}} + {σ}_{0} ( \vec{{x}_{l + 1}} ) , \vec{{r}_{l + 2}} + {σ}_{0} ( \vec{{x}_{l + 2}} ) , \vec{{r}_{l + 3}} + {σ}_{0} ( \vec{{x}_{l + 3}} ) )$$

$$\vec{{x}_{l}} = ( {x}_{0 , i} , … , {x}_{M - 1 , i} ) ( i = 0 , 1 , 2 , 3 )$$

$${x}_{j} = {x}_{j , 0} + {x}_{j , 1} + {x}_{j , 2} + {x}_{j , 3} + {x}_{j , 4} mod L$$

$$\vec{{r}_{l}} = ( {r}_{i , 0} , … , {r}_{i , j} , … , {r}_{i , m - 1} )$$

$${r}_{0 , j} + {r}_{1 , j} + {r}_{2 , j} + {r}_{3 , j} + {r}_{4 , j} = 0 mod L ( j = 0 , … , m - 1 )$$

In the above construction of mini-shuffles, of all the participants Pᵢ (i=0, 1, 2, 3, 4), each of the participants Pᵢ (i=1, 2, 3, 4) computes the permutation of the participant P₀ for the participant P₀ by using a permutation shared by the participants Pᵢ (i=1, 2, 3, 4) and sends the computed permutation to the participant P₀. However, alternatively, a combination of four participants Pᵢ and one participant P₀ may be changed. In this way, five mini-shuffles can be constructed. Each of these five mini-shuffles represents a permutation that is not traceable by one of the participants Pᵢ (i=0, 1, 2, 3, 4).

Thus, by synthesizing all the permutations σᵢ (i=0, 1, 2, 3, 4)∈S_{M}, each of which is not traceable by one of the participants Pᵢ (i=0, 1, 2, 3, 4), a permutation σ (shuffle) that is not traceable by any one of the participants Pᵢ (i=0, 1, 2, 3, 4) can be constructed.

$$σ = {σ}_{0} ∘ {σ}_{1} ∘ {σ}_{2} ∘ {σ}_{3} ∘ {σ}_{4} \qquad [ Equation 14 ]$$

### [Reconstruction]

The following description assumes a situation in which, when a participant Pᵢ reconstructs x, the participant Pᵢ receives a value xᵢ₊₄ of a share not held by the participant Pᵢ from the participants Pᵢ₊₁, Pᵢ₊₂, and Pᵢ₊₃. The participants Pᵢ₊₁ and Pᵢ₊₂ send the value xᵢ₊₄ to the participant Pᵢ without change, and the participant Pᵢ₊₃ sends a hash value hᵢ₊₄ of the value xᵢ₊₄ to the participant Pᵢ. Next, the participant Pᵢ computes the hash value of xᵢ₊₄ received from the participants Pᵢ₊₁ and Pᵢ₊₂ as hᵢ₊₁ and computes the hash value of xᵢ₊₄ received from the participant Pᵢ₊₂ as hᵢ₊₂.

In this situation, if hᵢ₊₁=hᵢ₊₂ or hᵢ₊₁=hᵢ₊₃, the participant Pᵢ adopts xᵢ₊₄ received from the participant Pᵢ₊₁ as an accurate value. If hᵢ₊₂=hᵢ₊₃, the participant Pᵢ adopts xᵢ₊₄ received from the participant Pᵢ₊₂ as an accurate value. In this way, by adopting the received values that are same at least two received values as an accurate value, even if one of the received value is a fake value, the participant Pᵢ can determine an accurate value. Next, by computing x=x₀+x₁+x₂+x₃+x₄ mod n with the accurate value xᵢ₊₄, the participant Pᵢ can reconstruct x.

In the reconstruction method described above, a participant receives xᵢ₊₄ (hash values thereof), which are supposed to be the same value, from at least three of the other participants Pⱼ and adopts the received values that are same at least two received values as an accurate value. In this way, even when one of the other participants Pⱼ is a dishonest person, it is possible to determine an accurate value. That is, even if there is a dishonest participant, it is possible to realize Guaranteed Output Delivery (GOD) that can acquire an accurate computation without stopping the processes. In addition, a hash function is used in the above processes. However, even if the input is deduced from the output, the security is not affected. Thus, Guaranteed Output Delivery (GOD) in the standard model is realized.

### [Magnitude Comparison (Private Compare)]

Next, a secure computation protocol, which is also referred to as Private Compare, will be described by using the above-described building blocks. This protocol is used to obtain a share of a result of a magnitude comparison from input of a share relating to a bit sequence and a value of a cleartext. That is, the following description will be made on a secure computation for obtaining a share [x>r]₂ of a result of a magnitude comparison from input of a share [x] on which bit decomposition and secret sharing have been performed and a value r which has not been made secret.

$${\{ {[ x {\vert}_{l} ]}_{p , i} \}}_{l = 0 , i = 0}^{{k}^{′} = 1 , 4} \qquad [ Equations 15 ]$$

$$where$$

$$x {\vert}_{l} ∈ \{ 0 , 1 \} f$$

$$or$$

$$l = 0 , … {k}^{′} - 1 ,$$

$${\{ {P}_{i} \}}_{i = 0}^{4}$$

$$r ∈ {\{ 0 , 1 \}}^{{k}^{′}}$$

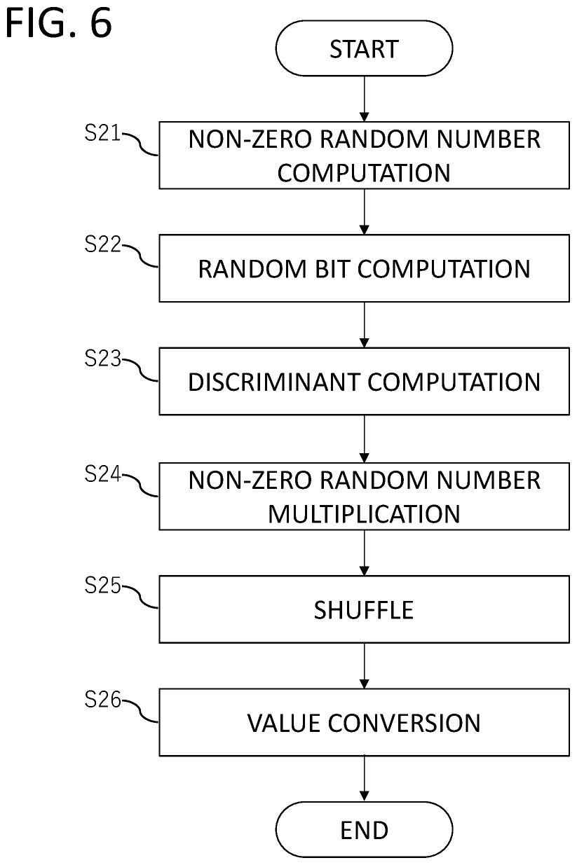

FIG. 6 is a flowchart illustrating a procedure of a protocol for a magnitude comparison (Private Compare). The magnitude comparison (Private Compare) protocol includes a non-zero random number computation step (S21), a random bit computation step (S22), a discriminant computation step (S23), a non-zero random number multiplication step (S24), a shuffle step (S25), and a value conversion step (S26). Hereinafter, the magnitude comparison (Private Compare) protocol will be described step by step.

### (Non-zero Random Number Computation Step: S21)

In the non-zero random number computation step (S21), as illustrated in the following Equations, shares [sₗ]ₚ and [s′ₗ]ₚ of non-zero random numbers are computed. The non-zero random number computation step can be performed offline. Specifically, from step 2 to step 8, the individual participants Pᵢ determinably generate non-zero random numbers s_{l,j} and s′_{l,j} by using their seeds and identifier as input. Next, from step 9 to step 13, the individual participants Pᵢ constitute formality shares by using the non-zero random numbers s_{l,j} and s′_{l,j}. However, the formality shares constituted from step 9 to step 13 are not actual shares. This is because, since the individual participants Pᵢ have only formalistically performed the distribution by using the non-zero random numbers s_{l,j} and s′_{l,j} generated thereby, the individual participants Pᵢ know the values of their own shares. Thus, from step 14 to step 21, multiplications are performed on the formality shares held by the individual participants Pᵢ, so as to compute the shares [sₗ]ₚ and [s′ₗ]ₚ of the non-zero random numbers that none of the participants Pᵢ know. The building block in the above-described [Secure Computation (Multiplication)] can be used for the multiplications for obtaining the shares [sₗ]ₚ and [s′ₗ]ₚ of the non-zero random numbers.

[Equations 16]

| | |
|---|---|
| 1: | (Offline phase) |
| 2: | for [symbol] = 0, . . . , k = 1 do |
| 3: | for i = 0, . . . , 4 do |
| 4: | for j = i, . . . , i + 3 do |
| 5: | Pᵢ computes s [symbol] _{,j} = Fₚ,(oid [symbol] _{,j}, kⱼ) where s [symbol] _{,4+1} = s [symbol] _{,0}, oid [symbol] _{,4+1} = |
| | oid [symbol] _{,0} and k₄₊₁ = k₀. |
| 6: | P [symbol] computes s′ [symbol] _{,j} = Fₚ,(oid′ [symbol] _{,j}, kⱼ) where s′ [symbol] _{,4+1} = s′ [symbol] _{,0}, oid′ [symbol] _{,4+1} = |
| | oid′ [symbol] _{,0} and k₄₊₁ = k₀. |
| 7: | end for |
| 8: | end for |
| 9: | P₀ sets [s [symbol] _{,0}]_{p,0} = (s [symbol] _{,0},0,0,0), [s [symbol] _{,1}]_{p,0} = (0, s [symbol] ,0,0), [s [symbol] _{,2}]_{p,0} = (0,0,s [symbol] _{,2},0), |
| | [s [symbol] _{,3}]_{p,0} = (0,0,0,s [symbol] _{,3}), [s [symbol] _{,4}]_{p,0} = (0,0,0,0), [s′ [symbol] _{,0}]_{p,0} = (s′ [symbol] _{,0},0,0,0), |
| | [s′ [symbol] _{,1}]_{p,0} = (0,s′ [symbol] _{,1},0,0), [s′ [symbol] _{,2}]_{p,0} = (0,0,s′ [symbol] _{,2},0), [s′ [symbol] _{,3}]_{p,0} = (0,0,0,s′ [symbol] _{,3}), |
| | and [s′ [symbol] _{,4}]_{p,0} = (0,0,0,0). |
| 10: | P₁ sets [s [symbol] _{,0}]_{p,1} = (0,0,0,0), [s [symbol] _{,1}]_{p,1} = (s [symbol] _{,1},0,0,0), [s [symbol] _{,2}]_{p,1} = (0, s [symbol] _{,2},0,0), |
| | [s [symbol] _{,3}]_{p,1} = (0,0,s [symbol] _{,3},0), [s [symbol] _{,4}]_{p,1} = (0,0,0,s [symbol] _{,4}), [s′ [symbol] _{,0}]_{p,1} = (0,0,0,0), |
| | [s′ [symbol] _{,1}]_{p,1} = (s′ [symbol] _{,1},0,0,0), [s′ [symbol] _{,2}]_{p,1} = (0,s′ [symbol] _{,2},0,0), [s′ [symbol] _{,3}]_{p,1} = (0,0,s′ [symbol] _{,3},0), |
| | and [s′ [symbol] _{,4}]_{p,1} = (0,0,0,s′ [symbol] _{,4}). |
| 11: | P₂ sets [s [symbol] _{,0}]_{p,2} = (0,0,0,s [symbol] _{,0}), [s [symbol] _{,1}]_{p,2} = (0,0,0,0), [s [symbol] _{,2}]_{p,2} = (s [symbol] _{,2},0,0,0), |
| | [s [symbol] _{,3}]_{p,2} = (0, s [symbol] _{,3}, 0,0), [s [symbol] _{,4}]_{p,2} = (0,0,s [symbol] _{,4},0), [s′ [symbol] _{,0}]_{p,2} = (0,0,0,s′ [symbol] _{,0}), |
| | [s′ [symbol] _{,1}]_{p,2} = (0,0,0,0), [s′ [symbol] _{,2}]_{p,2} = (s′ [symbol] _{,2}, 0,0,0), [s′ [symbol] _{,3}]_{p,2} = (0, s′ [symbol] _{,0},0,0), |
| | and [s [symbol] _{,4}]_{p,2} = (0,0,s [symbol] _{,4},0). |
| 12: | P₃ sets [s [symbol] _{,0}]_{p,3} = (0,0,s [symbol] _{,0},0), [s [symbol] _{,1}]_{p,2} = (0,0,0,s [symbol] _{,1}), [s [symbol] _{,2}]_{p,3} = (0,0,0,0), |
| | [s [symbol] _{,2}]_{p,3} = (s [symbol] _{,3},0,0,0), [s [symbol] _{,4}]_{p,3} = (0,s [symbol] _{,4},0,0), [s′ [symbol] _{,0}]_{p,3} = (0,0,s′ [symbol] _{,0},0), |
| | [s′ [symbol] _{,1}]_{p,3} = (0,0,0,s′ [symbol] _{,1}), [s′ [symbol] _{,2}]_{p,3} = (0,0,0,0), [s′ [symbol] _{,3}]_{p,3} = (s′ [symbol] _{,3},0,0,0), |
| | and [s′ [symbol] _{,4}]_{p,3} = (0,s′ [symbol] _{,4},0,0). |
| 13: | P₄ sets [s [symbol] _{,0}]_{p,4} = (0,s [symbol] _{,0},0,0), [s [symbol] _{,1}]_{p,4} = (0,0,s [symbol] _{,1},0), [s [symbol] _{,2}]_{p,4} = (0,0,0,s [symbol] _{,2}), |
| | [s [symbol] _{,3}]_{p,4} = (0,0,0,0), [s [symbol] _{,4}]_{p,4} = (s [symbol] _{,4},0,0,0), [s′ [symbol] _{,0}]_{p,4} = (0,s′ [symbol] _{,0},0,0), |
| | [s′ [symbol] _{,1}]_{p,4} = (0,0,s′ [symbol] _{,1},0), [s′ [symbol] _{,2}]_{p,4} = (0,0,0,s′ [symbol] _{,2}), [s′ [symbol] _{,3}]_{p,4} = (0,0,0,0), |
| | and [s′ [symbol] _{,4}]_{p,3} = (s′ [symbol] _{,4},0,0,0). |
| 14: | [s [symbol] _{,0} · s [symbol] _{,1}]ₚ ← [symbol] ([s [symbol] _{,0}]ₚ,[s [symbol] _{,1}]ₚ) |
| 15: | [s [symbol] _{,3} · s [symbol] _{,4}]ₚ ← [symbol] ([s [symbol] _{,3}]ₚ,[s [symbol] _{,4}]ₚ) |
| 16: | [s [symbol] _{,0} · s [symbol] _{,1} · s [symbol] _{,3} · s [symbol] _{,4}]ₚ ← [symbol] ([s [symbol] _{,0} · s [symbol] _{,1}]ₚ,[s [symbol] _{,3} · s [symbol] _{,4}]ₚ) |
| 17: | [s [symbol] ]ₚ = [s [symbol] _{,0} · s [symbol] _{,1} · s [symbol] _{,2} · s [symbol] _{,4}]ₚ ← [symbol] ([s [symbol] _{,0} · s [symbol] _{,1} · s [symbol] _{,3} · s [symbol] _{,4}]p, [s [symbol] _{,2}]ₚ) |
| 18: | [s′ [symbol] _{,0} · s′ [symbol] _{,1}]ₚ ← [symbol] ([s′ [symbol] _{,3}]ₚ, [s′ [symbol] _{,1}]ₚ) |
| 19: | [s′ [symbol] _{,3} · s′ [symbol] _{,4}]ₚ ← [symbol] ([s′ [symbol] _{,3}]ₚ, [s′ [symbol] _{,4}]ₚ) |
| 20: | [s′ [symbol] _{,0} · s′ [symbol] _{,1} · s′ [symbol] _{,3} · s′ [symbol] _{,4}]ₚ ← [symbol] ([s′ [symbol] _{,0} · s′ [symbol] _{,1}]ₚ, [s′ [symbol] _{,3} · s′ [symbol] _{,4}]ₚ) |
| 21: | [s′ [symbol] ]ₚ = [s′ [symbol] _{,0}·s′ [symbol] _{,1} · s′ [symbol] _{,2} · s′ [symbol] _{,3} · s′ [symbol] _{,4}]ₚ ← [symbol] ([s′ [symbol] _{,0} · s′ [symbol] _{,1} · s′ [symbol] _{,2} · s′ [symbol] _{,4}]ₚ,[s′ [symbol] _{,2}]ₚ) |
| 22: | end for |

[symbol]

indicates data missing or illegible when filed

### (Random Bit Computation Step: S22)

In the random bit computation step (S22), as illustrated in the following Equations, shares [b]₂ and [b]ₚ of random bits are computed. The random bit computation (S22) can be performed offline. Specifically, in step 23, the individual participants Pᵢ compute [b]ₚ by generating the share [b]₂ of a random bit by using a pseudo random function and seeds, and performing bit conversion on the generated share [b]₂ of the random bit. In this example, the building block in the above-described [Bit Conversion] can be used for the bit conversion for computing [b]ₚ from the share [b]₂ of the random bit.

[Equations 17]

23: Parties get the share of random bit [b]₂ by running [symbol] _{RBG}({Pᵢ}ᵢ₌₀⁴, {oidⱼ}ⱼ₌₀⁴).
24: Parties get the share of random bit on Z [symbol] [b]ₚ by running [symbol] _{BitConv}(p,[b]₂). [symbol]
indicates data missing or illegible when filed

### (Discriminant Computation Step: S23)

In the discriminant computation step (S23), as illustrated in the following Equations, the individual participants Pᵢ determine, per bit, whether a first bit sequence [x|ₗ] and a second bit sequence r|ₗ into which a value r of a cleartext is converted match each other and compute a sequence of a discriminant that indicates 0 when the first bit sequence indicates 1 and the second bit sequence indicates 0 at an n-th bit and when the first bit sequence and the second bit sequence match each other at an (n+1)th bit and higher. The discriminant computation step (S23) and its subsequent steps will be performed online.

First, from step 28 to step 30 and from step 31 to step 33, two operations are performed for a case in which a random bit b computed in the random bit computation step (S22) is 0 and for a case in which the random bit b computed in the random bit computation step (S22) is 1. Because the participant Pᵢ does not know whether the random bit b is 0 or 1, the participant Pᵢ computes discriminants [c|ₗ]ₚ and [c′|ₗ]ₚ for a case in which the random bit b is 0 and for a case in which the random bit b is 1, and selects one of the discriminants appropriately later.

If the random bit b is 0, the participant Pᵢ computes a sequence including the discriminant [c|ₗ]ₚ that indicates 0 when x>r. If the random bit b is 0, the participant Pᵢ computes a sequence including the discriminant [c′|ₗ]ₚ that indicates 0 when x≤r. However, because it is inconvenient to directly compute x≤r, the participant Pᵢ performs this computation as x<r+1. For this reason, t=r+1 is computed in step 26.

[Equations 18]

| | |
|---|---|
| 25: | (Online phase) |
| 26: | Let t [symbol] mod 2^{k}. |
| 27: | for [symbol] = k′ − 1,...,0 do |
| 28: | (Case of b = 0) |
| 29: | [w\| [symbol] ]ₚ = [x\| [symbol] ]ₚ + r\| [symbol] − 2r\|ⱼ[x\| [symbol] ]ₚ |
| 30: | [c\| [symbol] ]ₚ = r\| [symbol] − [x\| [symbol] ]ₚ + 1 + Σₘ₌ [symbol] ₊₁^{k-1}[w\|ₘ]ₚ |
| 31: | (Case of b = 1) |
| 32: | [w′\| [symbol] ]ₚ = [x\| [symbol] ]ₚ + t\| [symbol] − 2t\|ⱼ[x\| [symbol] ]ₚ |
| 33: | [c′\| [symbol] ]ₚ = t\| [symbol] + [x\| [symbol] ]ₚ + 1 + Σₘ₌ [symbol] ₊₁^{k-1} [w′\|ₘ]ₚ |
| 34: | end for |

[symbol]

indicates data missing or illegible when filed

In the above computation, the computation in step 29 is equivalent to an exclusive-or. That is, in step 29, whether the first bit sequence [x|ₗ]ₚ and the second bit sequence r|ₗ match each other or not is computed at each bit. Next, r|ₗ−[x|ₗ]ₚ+1 in step 30 is a term that indicates 0 when the first bit sequence indicates 1 and the second bit sequence indicates 0 at an lth bit, and the term of the sum Σ is a term that indicates 0 when the first bit sequence [x|ₗ]ₚ and the second bit sequence r|ₗ match each other at an (l+1)th bit and higher. In steps 31 and 32, the equivalent computation is performed for x<r+1.

### (Non-zero Random Number Multiplication Step: S24)

In the non-zero random number multiplication step (S24), as illustrated in the following Equations, the individual participant Pᵢ multiplies the discriminants [c|ₗ]ₚ and [c′|ₗ]ₚ by the shares [sₗ]ₚ and [s′ₗ]ₚ of the non-zero random numbers, respectively, so as to conceal the values in the sequences in which the discriminants [c|ₗ] and [c′|ₗ]ₚ do not indicate 0. The building block in the above-described [Secure Computation (Multiplication)] can be used for the multiplications.

[Equations 19]

35: [s [symbol] · c| [symbol] ]ₚ ← [symbol] ₘᵤₗₜ([s [symbol] ]ₚ, [c| [symbol] ]ₚ) for [symbol] = 0, . . . ,k′ − 1
36: [s′ [symbol] · c′| [symbol] ]ₚ ← [symbol] ₘᵤₗₜ([s′ [symbol] ]ₚ, [c′| [symbol] ]ₚ) for [symbol] = 0, . . . ,k′ − 1 [symbol]
indicates data missing or illegible when filed

### (Shuffle Step: S25)

In the shuffle step (S25), as illustrated in the following Equations, the individual participant Pᵢ shuffles the sequences [sₗ c|ₗ]ₚ and [s′ₗ c′|ₗ]ₚ obtained by multiplying the discriminants [c|ₗ]ₚ and [c′|ₗ]ₚ by the shares [sₗ]ₚ and [s′ₗ]ₚ of the non-zero random numbers, so as to conceal information about the digit of the bit for which the discriminant indicates 0. The building block in the above-described [Shuffle] can be used for the multiplications.

[Equations 20]

37: Parties get {[d| [symbol] ]ₚ} [symbol] ₌₀^{k′-1} by running [symbol] _{RShuffle}({[s [symbol] · c| [symbol] ]ₚ} [symbol] ₌₀^{k′-1}).
38: Parties get {[d′| [symbol] ]ₚ} [symbol] ₌₀^{k′-1} by running [symbol] _{RShuffle}({[s′ [symbol] · c′| [symbol] ]ₚ} [symbol] ₌₀^{k′-1}). [symbol]
indicates data missing or illegible when filed

### (Value Conversion Step: S26)

Although the discriminants [d|ₗ]ₚ and [d′|ₗ]ₚ obtained as described above include information about whether x>r, this does not indicate the share [x>r]₂ of the result of the magnitude comparison. Thus, as illustrated in the following Equations, the individual participant Pᵢ performs a computation for deriving the share [x>r]₂ of the result of the magnitude comparison from the discriminants [d|ₗ]ₚ and [d′|ₗ]ₚ.

[Equations 21]

| | |
|---|---|
| 39: | for [symbol] = k′ − 1,...,0 do |
| 40: | [d″\| [symbol] ]ₚ = (1 − [b]ₚ) · [d\| [symbol] ]ₚ + [b]ₚ · [d′\| [symbol] ]ₚ |
| 41: | P₀ reconstructs d″\| [symbol] by running [symbol] ({P₁, P₂, P₃}, {[d″\|ⱼ]_{p,1}, [d″\|ⱼ]_{p,2}, [d″\|ⱼ]_{p,3}}, P₀, [d″\|ⱼ]_{p,0}). |
| 42: | P₁ reconstructs d″\| [symbol] by running [symbol] ({P₂, P₃, P₄}, {[d″\|ⱼ]_{p,2}, [d″\|ⱼ]_{p,3}, [d″\|ⱼ]_{p,4}}, P₁, [d″\|ⱼ]_{p,1}). |
| 43: | P₂ reconstructs d″\| [symbol] by running [symbol] ({P₃, P₄, P₀}, {[d″\|ⱼ]_{p,3}, [d″\|ⱼ]_{p,4}, [d″\|ⱼ]_{p,0}}, P₂, [d″\|ⱼ]_{p,2}). |
| 44: | end for |
| 45: | P₀, P₁, and P₂ run [symbol] ([P₀, P₁, P₂}, 2, b′) and distribute [b′]₂ where b′ = |
| | [symbol] [symbol] ∈ {0, . . . ,k′ − 1} s.t. d″\| [symbol] = 0 then b′ = 0 else. |
| 46: | return [(x > r)]₂ = [b′]₂ [symbol] [b]₂. |

[symbol]

indicates data missing or illegible when filed

First, in step 40, depending on whether b is 0 or 1, an appropriate one of the values [d|ₗ]ₚ and [d′|ₗ]ₚ is selected. Next, from step 41 to step 42, the selected value of a discriminant [d′|ₗ]ₚ is reconstructed for the participants P₀, P₁, and P₂. The building block in the above-described [Reconstruction] can be used for the reconstruction.

Next, in step 45, the participants P₀, P₁, and P₂ reshare b′=1 if the reconstructed discriminant d″|ₗ includes 1 such that d″|ₗ=0. In contrast, the participants P₀, P₁, and P₂ reshare b′=0 if the reconstructed discriminant d″|ₗ does not include 1 such that d″|ₗ=0. The building block in the above-described [Reshare] can be used for the reconstruction.

Finally, by computing an exclusive-or on [b′]₂ and [b]₂ in step 46, the share [x>r]₂ of the result of the magnitude comparison can be obtained.

As described above, it is possible to obtain the share [x>r]₂ of the result of the magnitude comparison from input of the share [x] on which bit decomposition and secret sharing have been performed and the value r which has not been made secret. The above secure computation achieves Guaranteed Output Delivery (GOD) in the standard model in the used building blocks. Thus, a magnitude comparison secure computation in which a secure computation is performed by combining these building blocks also achieves Guaranteed Output Delivery (GOD) in the standard model.

### Third Example Embodiment

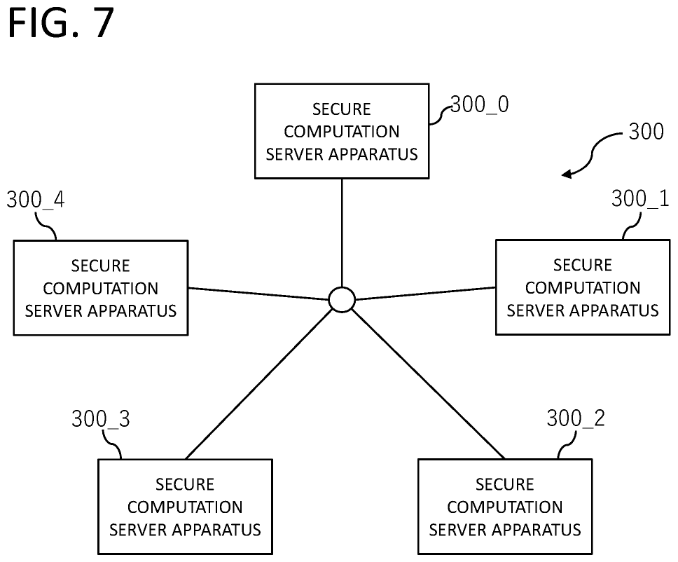

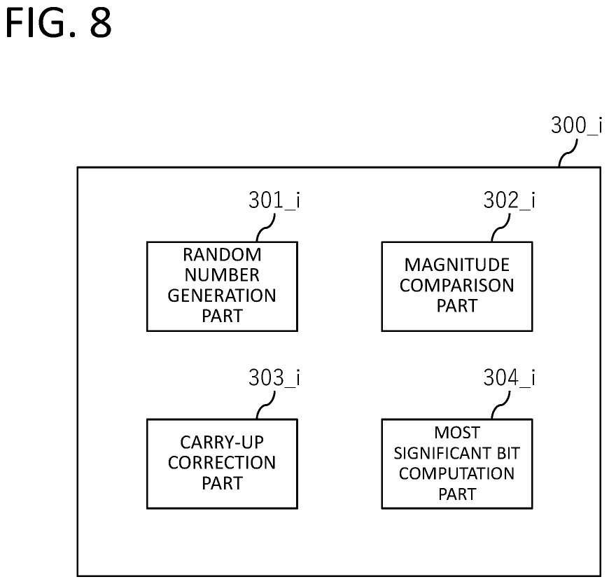

Next, a secure computation system and a secure computation server apparatus according to a third example embodiment will be described with reference to FIGS. 7 and 8. The third example embodiment is an example embodiment obtained by applying the first example embodiment or the second example embodiment to a most significant bit extraction protocol. Most significant bit extraction is a protocol for computing, from a value (share) dispersedly held by the individual secure computation server apparatuses, the most significant bit of the value while maintaining the secret state.

FIG. 7 is a block diagram illustrating a functional configuration example of the secure computation system according to the third example embodiment. As illustrated in FIG. 7, a secure computation system 300 according to the third example embodiment includes a first secure computation server apparatus 300_0, a second secure computation server apparatus 300_1, a third secure computation server apparatus 300_2, a fourth secure computation server apparatus 300_3, and a fifth secure computation server apparatus 300_4. The first secure computation server apparatus 300_0, the second secure computation server apparatus 300_1, the third secure computation server apparatus 300_2, the fourth secure computation server apparatus 300_3, and the fifth secure computation server apparatus 300_4 are connected to each other via a network such that these apparatuses can communicate with each other.

In the secure computation system 300 including the first to fifth secure computation server apparatuses 300_i (i=0, 1, 2, 3, 4), it is possible to compute target shares from a value inputted to any one of the first to fifth secure computation server apparatuses 300_i (i=0, 1, 2, 3, 4) while keeping the input value and the values acquired in the computation processes secret, and it is possible to dispersedly store the computation results in the first to fifth secure computation server apparatuses 300_i (i=0, 1, 2, 3, 4).

In addition, in the secure computation system 300 including the first to fifth secure computation server apparatuses 300_i (i=0, 1, 2, 3, 4), even when one of the first to fifth secure computation server apparatuses 300_i (i=0, 1, 2, 3, 4) is operated by a dishonest person, it is possible to continue an accurate secure computation without stopping the processes.

FIG. 8 is a block diagram illustrating a functional configuration example of a secure computation server apparatus according to the third example embodiment. As illustrated in FIG. 8, in the secure computation system 300 according to the present example embodiment, each of the first to fifth secure computation server apparatus 300_i (i=0, 1, 2, 3, 4) includes a random number generation part 301,_i a magnitude comparison part 302_i, a carry-up correction part 303,_i and a most significant bit computation part 304_i.

The random number generation part 301i generates a random number for masking an input value, and the magnitude comparison part 302_i performs a magnitude comparison between a value obtained by removing the most significant bit from the input value masked by the random number and a value obtained by removing the most significant bit from the random number. The carry-up correction part 303_i corrects, based on the result of the magnitude comparison, the computation of the value obtained by removing the most significant bit from the input value, and the most significant bit computation part 304_i computes the most significant bit of the input value by subtracting the value obtained by removing the most significant bit from the corrected input value from the input value.

With the most significant bit extraction protocol, information obtained by masking the input value by a random number needs to be sent, received, and processed. However, when a random number is added to an input value, the most significant bit could be carried up. To solve this, in the secure computation system 300 according to the present example embodiment, since each of the first to fifth secure computation server apparatuses 300_i (i=0, 1, 2, 3, 4) includes the random number generation part 301,_i the magnitude comparison part 302_i, the carry-up correction part 303_i, and the most significant bit computation part 304_i, the carry-up of the most significant bit, which could occur when the random number is added to the input value, can be corrected.

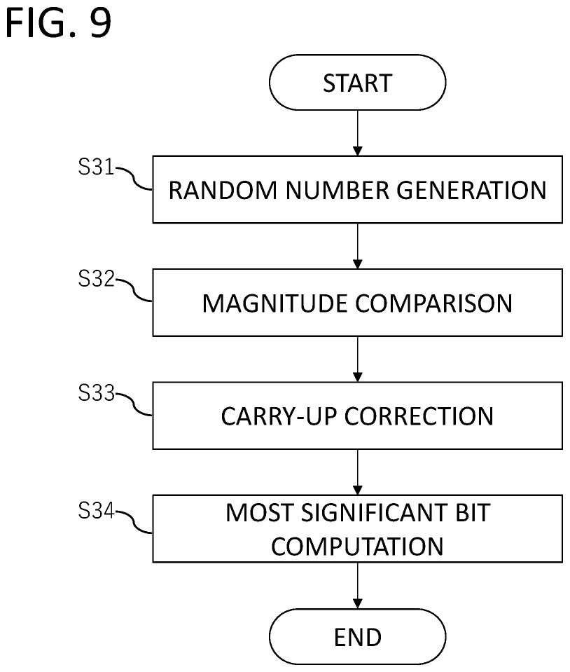

FIG. 9 is a flowchart illustrating a procedure of a protocol for extraction of the most significant bit. This most significant bit extraction protocol includes a random number generation step (S31), a magnitude comparison step (S32), a carry-up correction step (S33), and a most significant bit computation step (S34). Hereinafter, the most significant bit extraction protocol will be described step by step. The input and output of the most significant bit extraction protocol will be represented as follows.

$$Input : {[ a ]}_{{2}^{k}} s . t . a ∈ {Z}_{{2}^{k}} , \qquad [ Equations 22 ]$$

$$where$$

$$a = {\sum }_{j = 0}^{k - 1} {2}^{j} \cdot a {\vert}_{j}$$

$$Output : {[ msb ( a ) ]}_{2} ( = {[ a {\vert}_{k - 1} ]}_{2} )$$

### (Random Number Generation Step: S31)

In the random number generation step (S31), as illustrated in the following Equations, a share of a random number used for a mask is computed. The random number generation step (S31) can be performed offline. The individual participants Pᵢ determinably generate a random number by using seeds as input and perform bit decomposition on the generated random number, so as to create a bit sequence share of the random number. In addition, the most significant bit of a random number r will be denoted as msb(r).

[Equations 23]

| | |
|---|---|
| 1: | (Offline phase) |
| 2: | for [symbol] = 0, . . . ,k − 1 do |
| 3: | Parties get the share of random bit [r [symbol] ]₂ by running [symbol] _{RBG}({Pᵢ}ᵢ₌₀⁴, {oid [symbol] _{,j}}ⱼ₌₀⁴). |
| 4: | end for |
| 5: | for j = 0,...,k − 1 do |
| 6: | [r\|ⱼ]₂^{ₖ} ← [symbol] _{BitConv}₍₂_{^{k}}_{, [r\|}_{ⱼ}_{]}_{₂}₎ |
| 7: | [r\|ⱼ]ₚ ← [symbol] _{BitConv}(p, [r\|ⱼ]₂) |
| 8: | end for |
| 9: | [r\|_{k-2,...,0}]₂^{ₖ} = Σⱼ₌₀^{k-2} 2^{j} · [r\|ⱼ]₂^{ₖ} |
| 10: | [2^{k-1} · msb(r)]₂^{ₖ} = 2^{k-1} · [r\|ₖ₋₁_{]}_{₂}^{ₖ} |

[symbol]

indicates data missing or illegible when filed

### (Magnitude Comparison Step: S32)

In the magnitude comparison step (S32), as illustrated in the following Equations, a magnitude comparison between a value obtained by removing the most significant bit from an input value masked by the random number and a value obtained by removing the most significant bit from the random number. The magnitude comparison step (S32) and its subsequent steps will be performed online. In addition, in the magnitude comparison performed in the following step 15, the [magnitude comparison (Private Compare)] protocol described in the first example embodiment and the second example embodiment can be used as a building block.

[Equations 24]

| | |
|---|---|
| 11: | (Online phase) |
| 12: | [a + (r\|_{k-2,...,0})]₂^{ₖ} = [a]₂^{ₖ} + [r\|_{k-2,...,0}_{]}_{₂}^{ₖ} |
| 13: | [2 · ((a + r)\|_{k-2,...,0})]₂^{ₖ} = 2 · [a + (r\|_{k-2,...,0}_{)]}_{₂}^{ₖ} |
| 14: | Parties reconstruct 2 · ((a + r)\|_{k-2,...,0}) by running [symbol] ({Pᵢ}ᵢ₌₀⁴, {[2 · ((a + |
| | r)\|_{k-2,...,0})]₂^{ₖ}_{,i}^{}}ᵢ₌₀⁴) |
| 15: | [r\|_{k-2,...,0} > (a + r)\|_{k-2,...,0}] ← [symbol] _{RPC}(k − 1, {Pᵢ}ᵢ₌₀⁴, {[r [symbol] ]_{p,1}} [symbol] _{=0,i=0}^{k-2,4}, (a + |
| | r)\|_{k-2,...,0}) |

[symbol]

indicates data missing or illegible when filed

### (Carry-up Correction Step: S33)

In the carry-up correction step (S33), as illustrated in the following Equations, based on the result of the magnitude comparison step (S32), the computation of the value obtained by removing the most significant bit from the input value is corrected. In this way, the carry-up of the most significant bit, which could occur when the input value is masked by the random number, can be corrected.

[Equations 25]

| | |
|---|---|
| 16: | If (a+r)\|_{k-2,...,0} ≠ 2^{k-1}−1, Parties computes [a\|_{k-2,...,0}]₂^{ₖ} = [(a+r)\|_{k-2,...,0}_{]}_{₂}_{^{k}} − |
| | [r\|_{k-2,...,0}]₂^{ₖ} + 2^{k-1} · [r\|_{k-2,...,0} > (a + r)\|_{k-2,...,0}_{])]}_{₂}_{^{k}}. |
| | If (a+r)\|_{k-2,...,0} = 2^{k-1}−1, Parties computes [a\|_{k-2,...,0}]₂^{ₖ} = [(a+r)\|_{k-2,...,0}_{]}_{₂}_{^{k}} − |
| | [r\|_{k-2,...,0}]₂_{^{k}}. |

### (Most Significant Bit Computation Step: S34)

Finally, in the most significant bit computation step (S34), as illustrated in the following Equations, an exclusive-or on the most significant bit msb(r) of the random number r and the most significant bit msb(a) of an input value a is reconstructed, and the most significant bit msb(r) of the random number r as a mask is removed. In the reconstruction performed in this step 20, the above-described [Reconstruction] protocol can be used as a building block.

[Equations 26]

| | |
|---|---|
| 17: | [2^{k-1} · msb(a)]₂^{ₖ} = [2^{k-1} · a\|ₖ₋₁_{] = [} [symbol] ]_{₂}_{^{k}} − [a\|_{k-2,...,0}_{]}_{₂}^{ₖ} |
| 18: | [2^{k-1} · (msb(a) ⊕ msb(r))]₂^{ₖ} = [2^{k-1} · msb(a)]₂^{ₖ} + [2^{k-1} · msb(r)]₂^{ₖ} = 2^{k-1} · |
| | [a\|ₖ₋₁]₂^{ₖ} + 2^{k-1} · [r\|ₖ₋₁_{]}_{₂}^{ₖ} |
| 19: | for i = 0,...,3 do |
| 20: | Pᵢ gets 2^{k-1} ·(msb(a)⊕msb(r)) by running [symbol] ({Pᵢ₊₁, Pᵢ₊₂, Pᵢ₊₃}, {[2^{k-1} · |
| | (msb(a) ⊕ msb(r))]₂^{ₖ},ᵢ₊₁,[2^{k-1} · (msb(a) ⊕msb(r))]₂^{ₖ},ᵢ₊₂,[2^{k-1} · (msb(a) ⊕ |
| | msb(r))\|₂^{ₖ},ᵢ₊₃}, Pᵢ,[2^{k-1} · (msb(a) ⊕ msb(r))]₂^{ₖ}, [symbol] |
| 21: | end for |
| 22: | P₀ sets [msb(a) ⊕ msb(r)]_{2,0} = (msb(a) ⊕ msb(r), 0, 0, 0). |
| 23: | P₁ sets [msb(a) ⊕ msb(r)]_{2,1} = (0, msb(a) ⊕ msb(r), 0, 0). |
| 24: | P₂ sets [msb(a) ⊕ msb(r)]_{2,2} = (0, 0, msb(a) ⊕ msb(r), 0). |
| 25: | P₃ sets [msb(a) ⊕ msb(r)]_{2,3} = (0, 0, 0, msb(a) ⊕ msb(r)). |
| 26: | P₄ sets [msb(a) ⊕ msb(r)]_{2,4} = (0, 0, 0, 0). |
| 27: | [msb(a)]₂ = [msb(a) ⊕ msb(r)]₂ ⊕ [r\|ₖ₋₁]₂ |
| 28: | return [msb(a)]₂ |

[symbol]

indicates data missing or illegible when filed

As described above, it is possible to realize the most significant bit extraction protocol for computing, from a value held in a secret sharing manner, the most significant bit of the value while maintaining the secret state. The above secure computation achieves Guaranteed Output Delivery (GOD) in a standard model in a building block such as the magnitude comparison (Private Compare) used. Thus, a magnitude comparison secure computation in which a secure computation is performed by combining these building blocks also achieves Guaranteed Output Delivery (GOD) in the standard

### [Hardware Configuration Example]

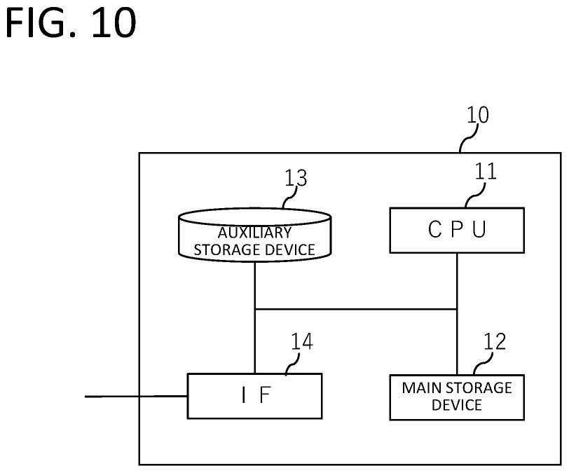

FIG. 10 is a diagram illustrating a hardware configuration example of a secure computation server apparatus. That is, the hardware configuration example illustrated in FIG. 10 is a hardware configuration example of any one of the secure computation server apparatuses 100_i, 200_i, and 300_i (i=0, 1, 2, 3, 4). An information processing apparatus (a computer) that adopts the hardware configuration illustrated in FIG. 10 can realize the individual functions of any one of the secure computation server apparatuses 100_i, 200i, and 300_i (i=0, 1, 2, 3, 4) by executing the corresponding one of the above secure computation methods as a program.

The hardware configuration example illustrated in FIG. 10 is an example of the hardware configuration that realizes the individual functions of any one of the secure computation server apparatuses 100i, 200_i, and 300_i (i=0, 1, 2, 3, 4), and does not limit the hardware configuration of any one of the secure computation server apparatuses 100_i, 200_i, and 300_i (i=0, 1, 2, 3, 4). The secure computation server apparatuses 100_i, 200_i, and 300_i (i=0, 1, 2, 3, 4) may include hardware not illustrated in FIG. 10.

As illustrated in FIG. 10, a hardware configuration 10 that can be adopted by any one of the secure computation server apparatuses 100i, 200_i, and 300_i (i=0, 1, 2, 3, 4) includes, for example, a CPU (Central Processing Unit) 11, a main storage device 12, an auxiliary storage device 13, and an IF (Interface) part 14, which are connected to each other via an internal bus.

The CPU 11 executes various commands included in the secure computation program executed by the corresponding one of the secure computation server apparatuses 100_i, 200_i, and 300_i (i=0, 1, 2, 3, 4). The main storage device 12 is, for example, a RAM (Random Access Memory) and temporarily stores various kinds of programs such as the secure computation program executed by the corresponding one of the secure computation server apparatuses 100_i, 200_i, and 300_i (i=0, 1, 2, 3, 4) so that the CPU 11 can execute the programs.

The auxiliary storage device 13 is, for example, an HDD (Hard Disk Drive) and can store, in the mid-to-long term, various kinds of programs such as the secure computation program executed by the corresponding one of the secure computation server apparatuses 100_i, 200_i, and 300_i (i=0, 1, 2, 3, 4). These various kinds of programs such as the secure computation program can be recorded in a non-transitory computer-readable storage medium and can be provided as a program product. The auxiliary storage device 13 can be used to store, in the mid-to-long term, various kinds of programs such as the secure computation program recorded in a non-transitory computer-readable storage medium. The IF part 14 provides an interface regarding the input and output among the corresponding secure computation server apparatuses 100_i, 200_i, or 300_i (i=0, 1, 2, 3, 4).

An information processing apparatus that adopts the hardware configuration 10 as described above realizes the functions of any one of the secure computation server apparatuses 100_i, 200_i, and 300_i (i=0, 1, 2, 3, 4) by executing the corresponding one of the above-described secure computation methods as a program.

The above example embodiments can partially or entirely be described, but not limited to, as the following notes.

### [Note 1]

A secure computation system, which includes five secure computation server apparatuses connected to each other via a network and obtains a share of a result of a magnitude comparison from input of a share relating to a first bit sequence and a value of a cleartext, an individual one of the secure computation server apparatuses including: a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher;
a shuffle part that shuffles the sequence of the discriminant to conceal information about the digit of the bit for which the discriminant indicates 0; and
a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

### [Note 2]

The secure computation system according to note 1;
wherein the shuffle part computes, by using a permutation shared by four of the five secure computation server apparatuses, a permutation of a share for a remaining one of the five secure computation server apparatuses, so as to construct a mini-shuffle, and synthesizes mini-shuffles regarding five combinations of four secure computation server apparatuses selected from the five secure computation server apparatuses; and
wherein the comparison and verification part compares permutations of the shares, which are received from at least three of the four secure computation server apparatuses and which are supposed to be a same value, and adopts the received permutations that are same at least two received permutations as an accurate permutation.

### [Note 3]

The secure computation system according to note 1 or 2; wherein, by multiplying the discriminant by a non-zero random number, a value(s) in a sequence for which the discriminant does not indicate 0 is concealed.

### [Note 4]

The secure computation system according to any one of notes 1 to 3; wherein the first bit sequence is a value obtained by removing a most significant bit from an input value masked by a random number; wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.

### [Note 5]

A secure computation server apparatus, which is one of five secure computation server apparatuses connected to each other via a network, to obtain a share of a result of a magnitude comparison from input of a share relating to a first bit sequence and a value of a cleartext, the secure computation server apparatus including:
a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher;
a shuffle part that shuffles the sequence of the discriminant to conceal information about the digit of the bit for which the discriminant indicates 0; and
a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

### [Note 6]

A secure computation method, which obtains a share of a result of a magnitude comparison from input of a share relating to a first bit sequence and a value of a cleartext by using five secure computation server apparatuses connected to each other via a network, an individual one of the secure computation server apparatuses performing: determining, per bit, whether the first bit sequence and a second bit sequence into which the value of the cleartext is converted match each other;
computing a sequence of a discriminant that indicates 0 when the first bit sequence indicates 1 and the second bit sequence indicates 0 at an n-th bit and when the first bit sequence and the second bit sequence match each other at an (n+1)th bit and higher;
shuffling the sequence of the discriminant to conceal information about the digit of the bit for which the discriminant indicates 0; and
comparing and verifying, in a communication performed in the shuffling of the discriminant, values with each other, which are received from at least three of the five secure computation server apparatuses and which are supposed to be a same value, and adopting the received values that are same at least two received values as an accurate value.

### [Note 7]

The secure computation method according to note 6;
wherein, in the shuffling, by using a permutation shared by four of the five secure computation server apparatuses, a permutation of a share for a remaining one of the five secure computation server apparatuses is computed, so as to construct a mini-shuffle, and mini-shuffles regarding five combinations of four secure computation server apparatuses selected from the five secure computation server apparatuses are synthesized; and
wherein, the comparing and verifying, permutations of the shares, which are received from at least three of the four secure computation server apparatuses and which are supposed to be a same value, are compared with each other, and the received permutations that are same at least two received permutations are adopted as an accurate permutation.

### [Note 8]

The secure computation method according to note 6 or 7; wherein, by multiplying the discriminant by a non-zero random number, a value(s) in a sequence for which the discriminant does not indicate 0 is concealed.

### [Note 9]

The secure computation method according to any one of notes 6 to 8; wherein the first bit sequence is a value obtained by removing a most significant bit from an input value masked by a random number; wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.

### [Note 10]

A secure computation program, causing five secure computation server apparatuses connected to each other via a network to perform a secure computation, to obtain a share of a result of a magnitude comparison from input of a share relating to a first bit sequence and a value of a cleartext, the secure computation program including:
determining, per bit, whether the first bit sequence and a second bit sequence into which the value of the cleartext is converted match each other;
computing a sequence of a discriminant that indicates 0 when the first bit sequence indicates 1 and the second bit sequence indicates 0 at an n-th bit and when the first bit sequence and the second bit sequence match each other at an (n+1)th bit and higher;
shuffling the sequence of the discriminant to conceal information about the digit of the bit for which the discriminant indicates 0; and
comparing and verifying, in a communication performed in the shuffling of the discriminant, values with each other, which are received from at least three of the five secure computation server apparatuses and which are supposed to be a same value, and adopting the received values that are same at least two received values being the same value, as an accurate value.

The disclosure of the above NPL is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literature that has been referred to in combination with what is disclosed in the present application should be deemed to be included in what is disclosed in the present application, as a part of the disclosure of the present invention.

### REFERENCE SIGNS LIST

100, 200, 300 secure computation system
100_i, 200_i, 300_i secure computation server apparatus
101_i, 201_i discriminant computation part
102_i, 202_i shuffle part
103_i, 203_i comparison and verification part
301_i random number generation part
302_i magnitude comparison part
303_i carry-up correction part
304_i most significant bit computation part
10 hardware configuration
11 CPU (Central Processing Unit)
12 main storage device
13 auxiliary storage device
14 IF (Interface) part

What is claimed is:

1. A secure computation system, which includes five secure computation server apparatuses connected to each other via a network and obtains a share of a result of a magnitude comparison from input of a share relating to a first bit sequence and a value of a cleartext, an individual one of the secure computation server apparatuses comprising:
a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher;
a shuffle part that shuffles the sequence of the discriminant to conceal information about the digit of the bit for which the discriminant indicates 0; and
a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

2. The secure computation system according to claim 1;
wherein the shuffle part computes, by using a permutation shared by four of the five secure computation server apparatuses, a permutation of a share for a remaining one of the five secure computation server apparatuses, so as to construct a mini-shuffle, and synthesizes mini-shuffles regarding five combinations of four secure computation server apparatuses selected from the five secure computation server apparatuses; and
wherein the comparison and verification part compares permutations of the shares, which are received from at least three of the four secure computation server apparatuses and which are supposed to be a same value, and adopts the received permutations that are same at least two received permutations as an accurate permutation.

3. The secure computation system according to claim 1; wherein, by multiplying the discriminant by a non-zero random number, a value(s) in a sequence for which the discriminant does not indicate 0 is concealed.

4. The secure computation system according to claim 1;
wherein the first bit sequence is a value obtained by removing a most significant bit from an input value masked by a random number;
wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.

5. A secure computation server apparatus, which is one of five secure computation server apparatuses connected to each other via a network, to obtain a share of a result of a magnitude comparison from input of a share relating to a first bit sequence and a value of a cleartext, the secure computation server apparatus including:
a discriminant computation part that determines, per bit, whether the first bit sequence and a second bit sequence into which the value of the cleartext is converted match each other and that computes a sequence of a discriminant that indicates 0 when the first bit sequence indicates 1 and the second bit sequence indicates 0 at an n-th bit and when the first bit sequence and the second bit sequence match each other at an (n+1)th bit and higher;
a shuffle part that shuffles the sequence of the discriminant to conceal information about the digit of the bit for which the discriminant indicates 0; and
a comparison and verification part that compares, in a communication performed in the shuffling of the discriminant, values with each other, which are received from at least three of the five secure computation server apparatuses and which are supposed to be a same value, and adopts the received values that are same at least two received values as an accurate value.

6. A secure computation method, which obtains a share of a result of a magnitude comparison from input of a share relating to a first bit sequence and a value of a cleartext by using five secure computation server apparatuses connected to each other via a network, an individual one of the secure computation server apparatuses performing:
determining, per bit, whether the first bit sequence and a second bit sequence into which the value of the cleartext is converted match each other;
computing a sequence of a discriminant that indicates 0 when the first bit sequence indicates 1 and the second bit sequence indicates 0 at an n-th bit and when the first bit sequence and the second bit sequence match each other at an (n+1)th bit and higher;
shuffling the sequence of the discriminant to conceal information about the digit of the bit for which the discriminant indicates 0; and
comparing and verifying, in a communication performed in the shuffling of the discriminant, values with each other, which are received from at least three of the five secure computation server apparatuses and which are supposed to be a same value, and adopting the received values that are same at least received values as an accurate value.

7. The secure computation method according to claim 6;
wherein, in the shuffling, by using a permutation shared by four of the five secure computation server apparatuses, a permutation of a share for a remaining one of the five secure computation server apparatuses is computed, so as to construct a mini-shuffle, and mini-shuffles regarding five combinations of four secure computation server apparatuses selected from the five secure computation server apparatuses are synthesized; and
wherein, in the comparing and verifying, permutations of the shares, which are received from at least three of the four secure computation server apparatuses and which are supposed to be a same value, are compared with each other, and the received permutations that are same at least two received permutations are adopted as an accurate permutation.

8. The secure computation method according to claim 6; wherein, by multiplying the discriminant by a non-zero random number, a value(s) in a sequence for which the discriminant does not indicate 0 is concealed.

9. The secure computation method according to claim 6;
wherein the first bit sequence is a value obtained by removing a most significant bit from an input value masked by a random number;
wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.

10. A non-transient computer readable medium storing a secure computation program, causing five secure computation server apparatuses connected to each other via a network to perform a secure computation, to obtain a share of a result of a magnitude comparison from input of a share relating to a first bit sequence and a value of a cleartext, the secure computation program including:
determining, per bit, whether the first bit sequence and a second bit sequence into which the value of the cleartext is converted match each other;
computing a sequence of a discriminant that indicates 0 when the first bit sequence indicates 1 and the second bit sequence indicates 0 at an n-th bit and when the first bit sequence and the second bit sequence match each other at an (n+1)th bit and higher;
shuffling the sequence of the discriminant to conceal information about the digit of the bit for which the discriminant indicates 0; and
comparing and verifying, in a communication performed in the shuffling of the discriminant, values with each other, which are received from at least three of the five secure computation server apparatuses and which are supposed to be a same value, and adopting the received values that are same at least two received values as an accurate value.

11. The secure computation server apparatus according to claim 5;
wherein the shuffle part computes, by using a permutation shared by four of the five secure computation server apparatuses, a permutation of a share for a remaining one of the five secure computation server apparatuses, so as to construct a mini-shuffle, and synthesizes mini-shuffles regarding five combinations of four secure computation server apparatuses selected from the five secure computation server apparatuses; and
wherein the comparison and verification part compares permutations of the shares, which are received from at least three of the four secure computation server apparatuses and which are supposed to be a same value, and adopts the received permutations that are same at least two received permutations as an accurate permutation.

12. The secure computation server apparatus according to claim 5; wherein, by multiplying the discriminant by a non-zero random number, a value(s) in a sequence for which the discriminant does not indicate 0 is concealed.

13. The secure computation server apparatus according to claim 5;
wherein the first bit sequence is a value obtained by removing a most significant bit from an input value masked by a random number;
wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.

14. The non-transient computer readable medium storing a secure computation program according to claim 10;
wherein, in the shuffling, by using a permutation shared by four of the five secure computation server apparatuses, a permutation of a share for a remaining one of the five secure computation server apparatuses is computed, so as to construct a mini-shuffle, and mini-shuffles regarding five combinations of four secure computation server apparatuses selected from the five secure computation server apparatuses are synthesized; and
wherein, in the comparing and verifying, permutations of the shares, which are received from at least three of the four secure computation server apparatuses and which are supposed to be a same value, are compared with each other, and the received permutations that are same at least two received permutations are adopted as an accurate permutation.

15. The non-transient computer readable medium storing a secure computation program according to claim 10; wherein, by multiplying the discriminant by a non-zero random number, a value(s) in a sequence for which the discriminant does not indicate 0 is concealed.

16. The non-transient computer readable medium storing a secure computation program according to claim 10;
wherein the first bit sequence is a value obtained by removing a most significant bit from an input value masked by a random number;
wherein the second bit sequence is a value obtained by removing a most significant bit from a random number; and
wherein, based on a result of a magnitude comparison between the first bit sequence and the second bit sequence, the computation of the value obtained by removing the most significant bit from the input value is corrected, and the most significant bit of the input value is computed by subtracting the corrected value obtained by removing the most significant bit from the input value from the input value.
